(19) United States
(12) Patent Application Publication
(10) Pub. No.: US 2025/0365114 A1
(43) Pub. Date: Nov. 27, 2025

(54) DEVICES AND METHODS FOR ASSIGNMENT OF RESOURCES FOR SIDELINK POSITIONING

(71) Applicant: HUAWEI TECHNOLOGIES CO., LTD., Shenzhen (CN)

(72) Inventors: Mario Hernán CASTAÑEDA GARCÍA, Munich (DE); Richard Stirling-Gallacher, Munich (DE)

(73) Assignee: HUAWEI TECHNOLOGIES CO., LTD., Shenzhen (CN)

(21) Appl. No.: 19/295,248

(22) Filed: Aug. 8, 2025

Related U.S. Application Data
(63) Continuation of application No. PCT/EP2023/053185, filed on Feb. 9, 2023.

(51) Int. Cl. H04L 5/00; H04W 72/044; H04W 72/25

(52) U.S. Cl. CPC H04L 5/0051; H04W 72/044; H04W 72/25

(57) ABSTRACT

Devices and methods for assignment of resources for sidelink positioning are disclosed. For instance, a UE (120a) is disclosed for transmitting an assignment of time and frequency resources for the transmission of one or more sidelink positioning reference signals, SL-PRSs. The UE (120a) is configured to transmit the assignment using a two-stage assignment, including a first stage assignment of one or more first time and frequency resources of a plurality of time and frequency resources with a first granularity and a second stage assignment of one or more second time and frequency resources of the plurality of time and frequency resources with a second granularity, wherein the one or more second time and frequency resources are a subset of the one or more first time and frequency resources.

### CROSS-REFERENCE TO RELATED APPLICATIONS

This application is a continuation of International Application No. PCT/EP2023/053185, filed on Feb. 9, 2023, the disclosure of which is hereby incorporated by reference in its entirety.

### TECHNICAL FIELD

The present disclosure relates to sidelink communication in wireless communication networks. More specifically, the present disclosure relates to devices and methods for assignment of resources for sidelink positioning in a wireless communication network.

### BACKGROUND

Communication between mobile devices, also referred to as user equipment (UEs), has been standardized in the form of sidelink (SL) communications since release 12 of the Long-Term Evolution (LTE) of the 3rd generation public partnership (3GPP) standard. The resources for sidelink communication may either be assigned by the network, if the UEs are in network coverage and are using licensed spectrum or they may be assigned in an autonomous distributed way by each UE when they are out of network coverage or are using unlicensed spectrum.

Several vehicle-to-everything (V2X) and public safety use cases can benefit from sidelink positioning, i.e., positioning based on the transmission and reception of sidelink positioning reference signals (SL-PRSs). 3rd Generation Partnership Project (3GPP) is currently studying SL positioning within their Release 18 (Rel. 18) as part of a study item on expanded and improved new radio (NR) positioning.

### SUMMARY

It is an objective of the present disclosure to provide devices and methods for the assignment of time and frequency resources for the transmission of SL-PRSs in a wireless communication network.

The foregoing and other objectives are achieved by the subject matter of the independent claims. Further implementation forms are apparent from the dependent claims, the description and the figures.

According to a first aspect a user equipment, UE, for transmitting an assignment of time and frequency resources for the transmission of one or more sidelink positioning reference signals, SL-PRSs, is provided. The UE is configured to transmit the assignment using a two-stage assignment, including a first stage assignment indicative of one or more first time and frequency resources of a plurality of time and frequency resources with a first granularity and a second stage assignment indicative of one or more second time and frequency resources of the plurality of time and frequency resources with a second granularity, wherein the one or more second time and frequency resources are a subset of the one or more first time and frequency resources. As used herein, the one or more second time and frequency resources being a subset of the one or more first time and frequency resources comprises the case that the one or more second time and frequency resources comprise all of the one or more first time and frequency resources, i.e. that the first and second time and frequency resources are identical.

In a further possible implementation form, the UE is configured to transmit a first stage sidelink control information, SCI, wherein the first stage SCI comprises the first stage assignment.

In a further possible implementation form, the UE is configured to transmit a second stage sidelink control information, SCI, wherein the second stage SCI comprises the second stage assignment.

In a further possible implementation form, the first stage SCI comprises information indicative of the presence of the second stage assignment.

In a further possible implementation form, the first stage SCI further comprises information about a format of the second stage SCI and/or wherein one or more reserved bits of the first stage SCI comprises the information indicative of the presence of the second stage assignment.

In a further possible implementation form, the plurality of time and frequency resources comprise a plurality of slots and a plurality of sub-channels.

In a further possible implementation form, the UE is configured to transmit the two-stage assignment, i.e. the first and the second assignment within one or more sub-channels of the plurality of slots and the plurality of sub-channels.

In a further possible implementation form, the UE is configured to transmit control information associated with the one or more SL-PRSs within the one or more sub-channels of the plurality of slots and the plurality of sub-channels that carry the two-stage assignment.

In a further possible implementation form, the UE is configured to transmit the two-stage assignment in a slot prior to one or more slots including the first time and frequency resources indicated by the two-stage assignment.

In a further possible implementation form, the UE is configured to transmit the two-stage assignment in the slot including the first time and frequency resources indicated by the two-stage assignment.

In a further possible implementation form, the UE is configured to transmit the one or more SL-PRSs on, i.e. using the second time and frequency resources as indicated by the second stage assignment.

In a further possible implementation form, the UE is configured to transmit the one or more SL-PRSs on, i.e. using the second time and frequency resources as indicated by the first and the second stage assignment.

In a further possible implementation form, the UE is configured to transmit the assignment of time and frequency resources using the two-stage assignment for the transmission of one or more of the one or more SL-PRSs by a further UE.

In a further possible implementation form, the first granularity is, i.e. has the size of a sub-channel of a slot.

In a further possible implementation form, the plurality of time and frequency resources comprise one or more configured or pre-configured semi-dedicated SL-PRS resources having the second granularity.

In a further possible implementation form, the plurality of time and frequency resources comprise one or more configured or pre-configured semi-dedicated SL-PRS resources, wherein the UE and/or a further UE is configured to transmit the one or more SL-PRSs on, i.e. using one or more SL-PRS resources of the one or more SL-PRS resources.

In a further possible implementation form, the UE is configured to transmit the two-stage assignment in one or more time and frequency resources of the plurality of time and frequency resources different to the one or more SL-PRS resources.

In a further possible implementation form, the UE is configured to transmit data in one or more time and frequency resources of the plurality of time and frequency resources including one or more of the one or more SL-PRS resources.

In a further possible implementation form, the UE is configured to transmit information associated with one or more of the one or more SL-PRS resources in one or more time and frequency resources of the plurality of time and frequency resources.

In a further possible implementation form, the UE is configured to receive configuration information about the one or more SL-PRS resources from a base station or from a second further UE.

In a further possible implementation form, the UE is configured to transmit one or more identifiers of one or more UEs intended to transmit the one or more SL-PRS on, i.e. using the second time and frequency resources.

In a further possible implementation form, the UE is configured to transmit one or more identifiers of one or more UEs intended to receive the one or more SL-PRS on, i.e. using the second time and frequency resources.

According to a second aspect a method for transmitting an assignment of time and frequency resources for the transmission of one or more sidelink positioning reference signals, SL-PRSs, is provided. The method comprises the step of transmitting the assignment using a two-stage assignment, including a first stage assignment indicative of one or more first time and frequency resources of a plurality of time and frequency resources with a first granularity and a second stage assignment indicative of one or more second time and frequency resources of the plurality of time and frequency resources with a second granularity, wherein the one or more second time and frequency resources are a subset of the one or more first time and frequency resources. As used herein, the one or more second time and frequency resources being a subset of the one or more first time and frequency resources comprises the case that the one or more second time and frequency resources comprise all of the one or more first time and frequency resources, i.e. that the first and second time and frequency resources are identical.

The method according to the second aspect of the present disclosure can be performed by the UE according to the first aspect of the present disclosure. Thus, further features of the method according to the second aspect of the present disclosure result directly from the functionality of the UE according to the first aspect of the present disclosure as well as its different implementation forms described above and below.

According to a third aspect a user equipment, UE, for receiving an assignment of time and frequency resources for the transmission of one or more sidelink positioning reference signals, SL-PRSs, is provided. The UE is configured to receive the assignment using a two-stage assignment, including a first stage assignment indicative of one or more first time and frequency resources of a plurality of time and frequency resources with a first granularity and a second stage assignment indicative of one or more second time and frequency resources of the plurality of time and frequency resources with a second granularity, wherein the one or more second time and frequency resources are a subset of the one or more first time and frequency resources. As used herein, the one or more second time and frequency resources being a subset of the one or more first time and frequency resources comprises the case that the one or more second time and frequency resources comprise all of the one or more first time and frequency resources, i.e. that the first and second time and frequency resources are identical.

In a further possible implementation form, the UE is configured to receive a first stage sidelink control information, SCI, wherein the first stage SCI comprises the first stage assignment.

In a further possible implementation form, the UE is configured to determine that the first stage SCI comprises the first stage assignment by determining that the first stage SCI indicates the second stage assignment.

In a further possible implementation form, the UE is configured to receive a second stage sidelink control information, SCI, wherein the second stage SCI comprises the second stage assignment.

In a further possible implementation form, the first stage SCI comprises information indicative of the presence of the second stage assignment.

In a further possible implementation form, the first stage SCI further comprises information about a format of the second stage SCI and/or one or more reserved bits of the first stage SCI comprises the information indicative of the presence of the second stage assignment.

In a further possible implementation form, the plurality of time and frequency resources comprise a plurality of slots and a plurality of sub-channels.

In a further possible implementation form, the UE is configured to receive the two-stage assignment, i.e. the first and the second assignment within one or more sub-channels of the plurality of slots and the plurality of sub-channels.

In a further possible implementation form, the UE is configured to receive control information associated with the one or more SL-PRSs within the one or more sub-channels of the plurality of slots and the plurality of sub-channels that carry the two-stage assignment.

In a further possible implementation form, the UE is configured to receive the two-stage assignment in a slot prior to one or more slots including the first time and frequency resources indicated by the two-stage assignment.

In a further possible implementation form, the UE is configured to receive the two-stage assignment in the slot including the first time and frequency resources indicated by the two-stage assignment.

In a further possible implementation form, the UE is configured to transmit the one or more SL-PRSs on, i.e. using the second time and frequency resources as indicated by the second stage assignment.

In a further possible implementation form, the UE is configured to transmit the one or more SL-PRSs on, i.e. using the second time and frequency resources as indicated by the first and the second stage assignment.

In a further possible implementation form, the UE is configured to receive the one or more SL-PRSs on, i.e. using the second time and frequency resources as indicated by the second stage assignment.

In a further possible implementation form, the UE is configured to receive the one or more SL-PRSs on, i.e. using the second time and frequency resources as indicated by the first and the second stage assignment.

In a further possible implementation form, the first granularity is, i.e. has the size of a sub-channel of a slot.

In a further possible implementation form, the plurality of time and frequency resources comprise one or more configured or pre-configured semi-dedicated SL-PRS resources having the second granularity, i.e. the same resolution as the one or more second time and frequency resources.

In a further possible implementation form, the plurality of time and frequency resources comprise one or more configured or pre-configured semi-dedicated SL-PRS resources, wherein the UE and/or a further UE is configured to transmit the one or more SL-PRSs on, i.e. using one or more SL-PRS resources of the one or more SL-PRS resources.

In a further possible implementation form, the UE is configured to receive the two-stage assignment in one or more time and frequency resources of the plurality of time and frequency resources different to the one or more SL-PRS resources.

In a further possible implementation form, the UE is configured to transmit data in one or more time and frequency resources of the plurality of time and frequency resources including one or more of the one or more SL-PRS resources.

In a further possible implementation form, the UE is configured to receive data in one or more time and frequency resources of the plurality of time and frequency resources including one or more of the one or more SL-PRS resources.

In a further possible implementation form, the UE is configured to transmit information associated with one or more of the one or more SL-PRS resources in one or more time and frequency resources of the plurality of time and frequency resources.

In a further possible implementation form, the UE is configured to receive information associated with one or more of the one or more SL-PRS resources in one or more time and frequency resources of the plurality of time and frequency resources.

In a further possible implementation form, the UE is configured to receive configuration information about the one or more SL-PRS resources from a base station or from a second further UE.

In a further possible implementation form, the UE is configured to receive one or more identifiers of one or more UEs intended to transmit the one or more SL-PRS on, i.e. using the second time and frequency resources.

In a further possible implementation form, the UE is configured to receive one or more identifiers of one or more UEs intended to receive the one or more SL-PRS on, i.e. using the second time and frequency resources.

According to a fourth aspect a method for receiving an assignment of time and frequency resources for the transmission of one or more sidelink positioning reference signals, SL-PRSs, is provided. The method comprises the step of receiving the assignment using a two-stage assignment, including a first stage assignment indicative of one or more first time and frequency resources of a plurality of time and frequency resources with a first granularity and a second stage assignment indicative of one or more second time and frequency resources of the plurality of time and frequency resources with a second granularity, wherein the one or more second time and frequency resources are a subset of the one or more first time and frequency resources. As used herein, the one or more second time and frequency resources being a subset of the one or more first time and frequency resources comprises the case that the one or more second time and frequency resources comprise all of the one or more first time and frequency resources, i.e. that the first and second time and frequency resources are identical.

The method according to the fourth aspect of the present disclosure can be performed by the UE according to the third aspect of the present disclosure. Thus, further features of the method according to the fourth aspect of the present disclosure result directly from the functionality of the UE according to the third aspect of the present disclosure as well as its different implementation forms described above and below.

According to a fifth aspect, a computer program product is provided, comprising a computer-readable storage medium for storing a program code which causes a computer or a processor to perform the method according to the second aspect or the method according to the fourth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a wireless communication network with several UEs according to an embodiment for transmitting and/or receiving an assignment of time and frequency resources for the transmission of one or more sidelink positioning reference signals;

FIG. 2 shows a schematic diagram illustrating a two-stage assignment of time and frequency resources for the transmission of one or more sidelink positioning reference signals implemented by a UE according to an embodiment;

FIG. 3 shows a schematic diagram illustrating semi-dedicated SL-PRS resources used for a two-stage assignment of time and frequency resources for the transmission of one or more sidelink positioning reference signals implemented by a UE according to an embodiment;

FIG. 4 shows a schematic diagram illustrating a two-stage assignment of time and frequency resources for the transmission of one or more sidelink positioning reference signals implemented by a UE according to an embodiment;

FIG. 5 shows a schematic diagram illustrating a two-stage assignment of time and frequency resources for the transmission of one or more sidelink positioning reference signals implemented by a first UE and a second UE according to an embodiment;

FIG. 6a shows a schematic diagram illustrating a two-stage assignment of time and frequency resources for the transmission of one or more sidelink positioning reference signals implemented by a UE according to an embodiment;

FIG. 6b shows a schematic diagram illustrating a two-stage assignment of time and frequency resources for the transmission of one or more sidelink positioning reference signals implemented by a UE according to an embodiment;

FIG. 7a shows a schematic diagram illustrating configuration steps implemented by a transmitting UE according to an embodiment for a two-stage assignment of time and frequency resources for the transmission of one or more sidelink positioning reference signals;

FIG. 7b shows a schematic diagram illustrating configuration steps implemented by a receiving UE according to an embodiment for a two-stage assignment of time and frequency resources for the transmission of one or more sidelink positioning reference signals;

FIG. 8 shows a signalling diagram illustrating a two-stage assignment of time and frequency resources for the transmission of one or more sidelink positioning reference signals implemented by a UE according to an embodiment;

FIG. 9 shows a flow diagram illustrating processing steps implemented by a transmitting UE according to an embodiment for a two-stage assignment of time and frequency resources for the transmission of one or more sidelink positioning reference signals implemented by a UE according to an embodiment;

FIG. 10 shows a schematic diagram illustrating processing steps implemented by a transmitting UE according to an embodiment for a two-stage assignment of time and frequency resources for the transmission of one or more sidelink positioning reference signals;

FIG. 11 shows a schematic diagram illustrating processing steps implemented by a transmitting UE according to an embodiment for a two-stage assignment of time and frequency resources for the transmission of one or more sidelink positioning reference signals;

FIG. 12 shows a flow diagram illustrating processing steps implemented by a transmitting UE according to an embodiment for a two-stage assignment of time and frequency resources for the transmission of one or more sidelink positioning reference signals;

FIG. 13 shows a schematic diagram illustrating a two-stage assignment of time and frequency resources for the transmission of one or more sidelink positioning reference signals implemented by a UE according to an embodiment;

FIG. 14 shows a flow diagram illustrating processing steps implemented by a receiving UE according to an embodiment for a two-stage assignment of time and frequency resources for the transmission of one or more sidelink positioning reference signals;

FIG. 15 shows a schematic diagram illustrating semi-dedicated SL-PRS resources used for a two-stage assignment of time and frequency resources for the transmission of one or more sidelink positioning reference signals implemented by a UE according to an embodiment;

FIG. 16 shows a signalling diagram illustrating a two-stage assignment of time and frequency resources based on semi-dedicated SL-PRS resources for the transmission of one or more sidelink positioning reference signals implemented by a UE according to an embodiment;

FIG. 17 is a flow diagram illustrating a method according to an embodiment for transmitting a two-stage assignment of time and frequency resources for the transmission of one or more sidelink positioning reference signals; and

FIG. 18 is a flow diagram illustrating a method according to an embodiment for receiving a two-stage assignment of time and frequency resources for the transmission of one or more sidelink positioning reference signals.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

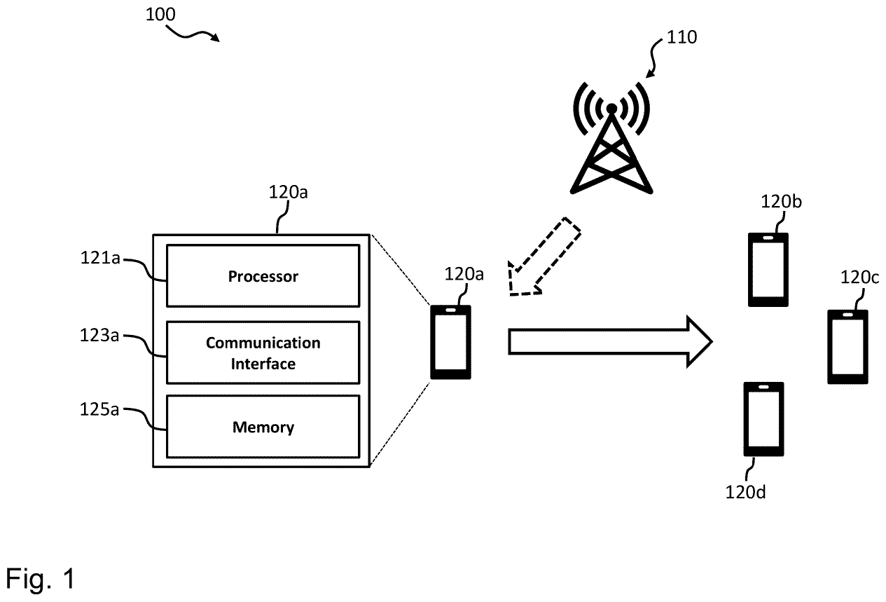

FIG. 1 shows a schematic diagram illustrating a wireless communication network, in particular cellular communication network 100 with a base station 110 defining a cell of the wireless communication network 100 and a plurality of user equipment, UEs, 120a-d according to an embodiment for transmitting and/or receiving an assignment of time and frequency resources for the transmission of one or more sidelink positioning reference signals, SL-PRSs. By way of example, in FIG. 1, the UE 120a transmits an assignment of time and frequency resources for the transmission of one or more sidelink positioning reference signals, SL-PRSs.

As illustrated in FIG. 1, the UE 120a may comprise a processing circuitry 121a and a communication interface 123a, in particular an antenna, for communication with the base station 110 and sidelink communication with the other UEs 120b-d in the wireless network 100. The processing circuitry 121a may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the UE 120a may comprise a memory 125a configured to store executable program code which, when executed by the processing circuitry 121a, causes the UE 120a to perform the functions and operations described herein. Similar to the UE 120a, the other UEs 120b-d may comprise a processing circuitry, a communication interface and a memory as well.

By way of example, further below several detailed embodiments will be described, wherein the UE 120a (also referred to as first UE) is transmitting an assignment of time and frequency resources for the transmission of one or more SL-PRSs, while the UEs 120b-d may receive such an assignment. Moreover, by way of example, the UE 120d may be a legacy UE 120d, as defined in more detail further below.

Embodiments disclosed herein relate to the assignment of time and frequency resources in the sidelink for the transmission of SL-PRSs. Transmissions in the sidelink may use a orthogonal frequency division multiplexing (OFDM) waveform with a cyclic prefix (CP). In the time domain, resources may consist of slots. A slot consists of multiple OFDM symbols, e.g. 14 or 12 OFDM symbols depending whether a normal or an extended CP is employed. In the following OFDM symbols are simply referred to as symbols and it is assumed that a slot consists of 12 symbols. In the frequency domain, resources may consist of resource blocks (RBs). An RB consists of multiple adjacent subcarriers, e.g. 12 subcarriers, with the same subcarrier spacing for the OFDM waveform.

For data transmissions in the sidelink, e.g. in NR-V2X in 3GPP Rel. 16/17, a subset of available resources may be (pre-)configured to be used by the UEs 120a-d for their SL transmissions. A subset of available resources for SL transmissions is referred to as a resource pool (RP). (Pre-)configuration refers to (a) a configuration that is defined by the network and that it is signaled to the UE 120a-d by the network device base station 110, i.e., when the UE 120a-d is in network coverage or (b) a configuration that is predefined in the UE 120a-d, e.g. when the UE 120a-d is out of network coverage. A network device base station 110 can be a next generation node B (gNB), a base station (BS), a roadside unit (RSU), a transmit/receive point (TRP) or the like. A UE 120a-d can be a mobile phone, a handheld device, a device on a vehicle or a device on a robot, or the like. In the following the term gNB is used with the understanding that the unit may be implemented as a network device 110 in general. As already described above, by way of example, the UE 120d may be a legacy UE 120d, while the UEs 120a-c are implemented according to embodiments disclosed herein.

In the time domain, an RP consists of contiguous or non-contiguous slots. Within a slot, all symbols or only a subset of the available symbols may be (pre-)configured for sidelink transmissions. The resource blocks within a resource pool are also referred to as physical resource blocks (PRBs). In the frequency domain, an RP is divided into a (pre-)configured number of contiguous sub-channels. A sub-channel consists of a set of adjacent PRBs in a slot. The number of PRBs in a sub-channel is (pre-)configured within a resource pool. A sub-channel represents the smallest unit for scheduling a data transmission in the sidelink. A transmission in the sidelink can occupy one or multiple sub-channels.

The data is organized in transport blocks (TBs), e.g., a TB can contain an entire data packet. In NR V2X, the data payload, i.e, a TB, is carried in the Physical Sidelink Shared Channel (PSSCH). Depending on the size of the data packet, the PSSCH carrying a TB can occupy one or more sub-channels. The sidelink control information (SCI) associated with a TB is sent in two stages: a 1^{st}-stage SCI and a 2^{nd}-stage SCI. The 1^{st}-stage is carried in the Physical Sidelink Control Channel (PSCCH). The PSCCH is multiplexed with the associated PSSCH in non-overlapping resources within the sub-channel(s) occupied by the PSSCH. To aid in the decoding of the PSCCH, demodulation reference signals (DMRS) are sent within the PSCCH, which are referred as PSCCH DMRS. The 2^{nd}-stage SCI is multiplexed in time and frequency with the TB in a PSSCH. To aid in the decoding of the PSSCH, demodulation reference signals (DMRS) are sent within the PSSCH, which are referred to as PSSCH DMRS. For a transmission of a TB, a transmitting UE (Tx UE) 120a-d sends a PSCCH (carrying the 1^{st}-stage SCI) along with the 2^{nd}-stage SCI multiplexed with the TB in a PSSCH in one or more sub-channels.

The 1^{st}-stage SCI indicates the resource(s) of the current TB transmission and it can also indicate resources reserved for retransmissions of the same TB. The current TB transmission can be referred to as initial transmission. The initial transmission can correspond to a retransmission. The resource(s) for a transmission comprises one or more sub-channel(s) in one slot. The resource(s) of a transmission can be determined with the frequency resource location and time resource location of the resources. The frequency resource location of the resources can be indicated with a starting sub-channel index and the number of contiguously allocated sub-channels for a transmission. The time resource location can be indicated with a slot index. The starting sub-channel and slot of the resources for the current TB transmission correspond to the sub-channel and slot on which the PSCCH (that carries the 1^{st}-stage SCI associated with the TB) is located. Based on this, the resources of a current transmission can be determined with the indication of the number of contiguous sub-channels occupied by the current transmission. The resources of a retransmission are indicated with a frequency indication value and time indication value that specify the starting sub-channel index, the number of contiguously allocated sub-channels and the subsequent slot index of the retransmission.

In addition, the 1^{st}-stage SCI can also indicate a resource reservation period, which is the time period between resources selected for the transmission of consecutive TBs. This period indicates the periodicity of resources selected by the UE 120a-d and is referred to as resource reservation interval (RRI) in NR V2X. With the RRI in the 1^{st}-stage SCI, a UE 120a-d can indicate that the sub-channel(s) used for the current transmission of the TB can be reserved after the RRI for the transmission of a new TB. Multiple RRIs can be (pre-)configured in a resource pool.

Decoding of the 1^{st}-stage SCI can then allow a UE 120a-d to be aware of the sub-channel(s) occupied by a current transmission of a TB carried in a PSSCH, as well as to be aware of the sub-channel(s) which are reserved for future (re) transmissions of the same TB or of a new TB. The 1^{st}-stage SCI also indicates a priority of the TB carried in the associated PSSCH. In addition, the 1^{st}-stage SCI also indicates the format of the 2^{nd}-stage SCI, as the 2^{nd}-stage SCI can have variable length. The 2^{nd}-stage SCI indicates the source ID and the destination ID of a TB. Decoding the 2^{nd}-stage SCI, allows a receiving UE 120a-d (Rx UE) to know the source and destination of a TB, i.e., it allows a Rx UE 120a-d to be aware if it is a target Rx UE 120a-d of a TB carried in a PSSCH.

For data transmissions, i.e. for a transmission of a TB, the sub-channels within a resource pool can be selected based on two resource allocation modes, namely mode 1 and mode 2. In mode 1, the sub-channel(s) for a data transmission are assigned by the network, i.e., the base station or gNB 110 indicates to a UE 120a-d the resources that it shall use for a data transmission. In mode 2, a UE 120a-d can autonomously select sub-channel(s) for a data transmission.

For a transmission in mode 2, a UE 120a-d identifies candidate resources in a selection window based on a sensing procedure within a set of slots of the resource pool. This set of slots is referred to as a sensing window. As part of the sensing procedure, a UE 120a-d searches for a PSCCH at all potential PSCCH locations in each sub-channel of these slots and decodes the 1^{st}-stage SCI if it finds a PSCCH. Based on the decoded 1^{st}-stage SCIs, the UE 120a-d is aware of resources that have been reserved by other UEs 120a-d for their transmissions. In addition, the UE 120a-d measures the reference signal received power (RSRP) of the transmission associated with a received 1^{st}-stage SCI. It can be (pre-)configured per resource pool, whether the UEs 120a-d shall measure the RSRP based on the PSCCH DMRS or based on the PSSCH DMRS. The measured RSRPs and the resources reserved by the corresponding 1^{st}-stage SCI are considered to be the sensing results from the mode 2 sensing of the UE 120a-d.

With mode 2, the UE 120a-d determines candidate resources within the selection window after excluding resources within the selection window based on the half-duplex operation and based on the sensing results. Due to the half-duplex operation, a UE 120a-d cannot sense for reservations from other UEs 120a-d on the slots in the sensing window where the UE 120a-d was transmitting. Based on this, the UE 120a-d excludes slots in the selection window with potentially reserved resources due to an RRI period indicated in a 1^{st}-stage sent in the slots of the sensing window when the UE 120a-d was transmitting. The UE 120a-d can also exclude slots that if selected by the UE 120a-d for resources to be used with a given RRI period (selected by the UE 120a-d for its transmissions), may result in a future collision with the potentially reserved resources of other UEs 120a-d. In addition, based on the sensing results, the UE 120a-d also excludes reserved resources in the selection window with an associated measured RSRP larger than a (pre-)configured threshold, that depends on the priority of the TB to be sent by the UE 120a-d. The UE 120a-d can also exclude resources that if selected by the UE 120a-d to be used with a given RRI period, may result in a future collision with reserved resources of other UEs 120a-d. After the exclusions, the UE 120a-d checks if the percentage of remaining available candidate resources within the selection window is above a threshold, that depends on the priority of the TB to be sent by the UE 120a-d. If this is not the case, the RSRP threshold used to exclude reserved resources is increased by 3 dB and the resource exclusion based on the sensing results is repeated. Among the remaining candidate resources in the selection window, the UE 120a-d randomly selects resources for the initial transmissions and retransmissions of the TB. The UE 120a-d can use the selected resources for multiple periods, i.e., with a given RRI selected by the UE 120a-d, for sending multiple TBs.

Mechanisms to enhance the mode 2 operation include re-evaluation and pre-emption. With re-evaluation, a UE 120a-d can check, based on new sensing results prior to the transmission of a TB by the UE 120a-d, if a selected resource for the TB has been reserved by another UE 120a-d. If this is the case, the UE 120a-d drops the selected resource and selects a new resource for the TB. With pre-emption, a UE 120a-d can also check if a selected resource for a TB has been reserved, similar to the re-evaluation mechanism. However, with pre-emption, a UE 120a-d only selects a new resource for its transmission of the TB, if the resource has been reserved by another UE 120a-d for a transmission with higher priority compared to the priority of the UE's transmission. A UE 120a-d can also select a new resource for its transmission, if the priority associated with the reserved resource is higher than a (pre-)configured threshold within the resource pool.

For the resource allocation of SL-PRS, it has been discussed in 3GPP that scheme 1 and scheme 2 similar to mode 1 (i.e. network-controlled) and mode 2 (autonomous selection by a UE) for data transmission, respectively, should be introduced. In the following we refer to scheme 1 as mode 1 and scheme 2 as mode 2.

For the transmission of SL-PRSs, time and frequency resources in the sidelink are required. Similar to data transmissions in the sidelink, resources in a resource pool can be used for SL-PRS transmissions. For this purpose, it has been discussed in 3GPP whether to use a dedicated shared resource pool and/or a shared resource pool for SL-PRS, including (pre-)configuring either one of them. A dedicated resource pool refers to a resource pool with resources used for SL-PRS transmissions as well as possibly for transmissions of SCI or other information associated with SL-PRS resources. PSCCH can be sent in a dedicated resource pool, where the PSCCH carries SCI associated with SL-PRS transmission(s). PSSCH associated with SL-PRS transmission(s) can also be sent in a dedicated resource pool, e.g., PSSCH carrying a measurement report of SL-PRS transmission(s). A shared resource pool refers to a resource pool with resources used for data and SL-PRS transmissions as well as for transmitting information (e.g., SCI) associated with these transmissions. In addition, it has been agreed in 3GPP that backward compatibility for legacy UEs, such as the exemplary UE 120d, should be supported in a shared resource pool. A legacy UE, such as the exemplary UE 120d, refers to a UE of a previous release, i.e., to a Rel. 16 or Rel. 17 UE in NR V2X. Non-legacy as used herein corresponds to UEs of further releases, e.g. Rel. 18, such as, by way of example, the UEs 120a-c illustrated in FIG. 1.

Data transmissions are allocated in units of sub-channels. A SL-PRS may span multiple PRBs (e.g., the entire resource pool) in the frequency domain and occupy multiple symbols in the time domain. Thus, a SL-PRS resource may not correspond to one or more multiple sub-channels. As a result, the resource granularity of data transmissions and SL-PRS in the sidelink may be different. A shared resource pool needs to support the resource selection and scheduling of these two types of transmissions with different resource granularities.

In addition, it has been proposed to multiplex SL-PRS with a PSSCH. However, a UE 120a-c that wants to transmit SL-PRS may not always need to send a PSSCH. In addition, the SL-PRS may need to span multiple sub-channels while a PSSCH may not need to occupy so many sub-channels. Furthermore, a SL-PRS may not need to span all the symbols in a slot.

A shared resource pool shall support data transmissions from Rel. 16/17/18 Tx UEs 120d to Rel. 16/17/18 Rx UEs and SL-PRS transmissions from Rel. 18 Tx UEs 120a-c to Rel. 18 Rx UEs 120a-c. As Rel. 16/17 Rx UEs 120d do not need to receive SL-PRS, backward compatibility in a shared resource pool is ensured for legacy Rx UEs 120d, as long as these Rx UEs 120d can receive their intended data. Backward compatibility needs to be ensured for Rel. 16/17 Tx UEs 120d in scheme 1 (mode 1) and scheme 2 (mode 2). In mode 1, resources for data and SL-PRS can be configured by the network for Rel. 16/17 Tx UEs 120d and Rel. 18 Tx UEs 120a-c. To ensure backward compatibility, Rel. 16/17 Tx UEs 120d performing mode 2 sensing need to be aware of SL-PRS resources reserved by Rel. 18 Tx UEs 120a-c, without being able to identify that such resources are for SL-PRS. However, Rel. 16/17 Tx UEs 120d performing mode 2 sensing can only be aware of resource reservations on a sub-channel granularity. On the other hand, Rel. 18 Tx UEs 120a-c performing mode 2 sensing (for sending SL-PRS) need to be aware of the SL-PRS resource reservations (made by other Rel. 18 Tx UEs 120a-c) on a SL-PRS resource granularity.

The use of a dedicated resource pool may be inefficient as resources which are dedicated for SL-PRS may not always be used while reducing the available resources for data transmission in the sidelink. A shared resource pool provides a better use of the resources, but may require backward compatibility. In addition, a shared resource pool needs to accommodate the scheduling of transmission with different resource granularities. Furthermore, multiplexing SL-PRS within a PSSCH may impose that a PSSCH needs to be sent with a SL-PRS and that a PSSCH spans more sub-channels than necessary. Multiplexing SL-PRS within a PSSCH may limit the design of SL-PRS.

Embodiments disclosed herein provide a shared resource pool for supporting data transmissions and SL-PRS transmissions (i.e., for Rel. 18 UEs 120a-c), considering different granularities of resources for both types of transmissions, e.g., in units of sub-channels for data transmissions and units of SL-PRS resources for SL-PRS. The design of the shared resource pool ensures backward compatibility for legacy UEs 120d, i.e. for Rel. 16 and Rel. 17 UEs 120d. The data transmissions in the shared resource pool can be performed by all UEs, i.e. Rel. 16/17/18 UEs 120a-d. The transmissions of SL-PRS can be performed by non-legacy UEs, i.e., Rel. 18 UEs 120a-c.

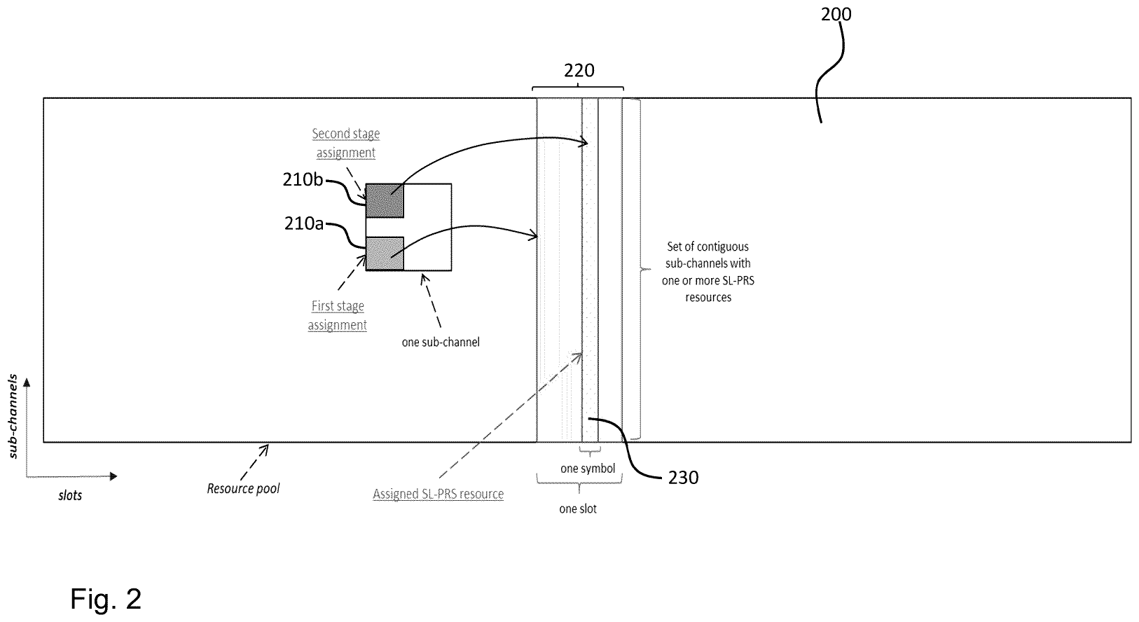

As illustrated in FIG. 2, embodiments disclosed herein generally provide a scheme for a two-stage assignment (also referred to as two-stage reservation) of one or more SL-PRS resources. A first stage assignment 210a (also referred to as a first stage reservation) assigns, i.e. reserves a set of contiguous sub-channels that include the one or more SL-PRS resources. A second stage assignment 210b (also referred to as a second stage reservation) assigns, i.e. reserves one or more resources within the set of sub-channels for the one or more SL-PRS resources. An assignment of time and frequency resources is also referred to as a reservation and herein the terms “assignment” and “reservation” are used interchangeably.

More specifically, for transmitting an assignment of time and frequency resources for the transmission of one or more SL-PRSs, for instance, the UE 120a is configured to transmit the assignment using a two-stage assignment, including the first stage assignment 210a indicative of one or more first time and frequency resources 220 of a plurality of time and frequency resources 200 with a first granularity and a second stage assignment 210b indicative of one or more second time and frequency resources 230 of the plurality of time and frequency resources 200 with a second granularity, wherein the one or more second time and frequency resources 230 are a subset of the one or more first time and frequency resources 220. As used herein, the one or more second time and frequency resources 230 being a subset of the one or more first time and frequency resources 220 comprises the case that the one or more second time and frequency resources 230 comprise all of the one or more first time and frequency resources 220, i.e. that the first and second time and frequency resources 220, 230 are identical.

Likewise, for receiving the assignment of time and frequency resources for the transmission of the one or more SL-PRSs, for instance, the UE 120b is configured to receive the assignment using a two-stage assignment, including the first stage assignment 210a indicative of the one or more first time and frequency resources 220 of the plurality of time and frequency resources 200 having the first granularity and the second stage assignment 210b indicative of the one or more second time and frequency resources 230 of the plurality of time and frequency resources 200 having the second granularity. As already described above, the one or more second time and frequency resources 230 are a subset of the one or more first time and frequency resources 220.

The advantage of the two-stage assignment is that it supports the assignment of SL-PRS resources in a shared resource pool, while allowing the assignment of SL-PRS resources with a different granularity than that of the data transmissions. The example illustrated in FIG. 2 depicts a two-stage assignment for one SL-PRS resource in one symbol. A SL-PRS resource within the set of sub-channels can span multiple symbols and can span the set of sub-channels in a comb pattern or structure. The first stage assignment 210a is intended for all UEs 120a-d, i.e. for UEs 120a-d (legacy and non-legacy) that intend to transmit or receive data or that intend to transmit or receive SL-PRS, while the second stage assignment 210b is intended for UEs 120a-c (non-legacy) that intend to transmit or receive SL-PRS. The two-stage assignment can be sent by a Rel. 18 Tx UE 120a-c that wants to reserve a SL-PRS resource for a future transmission of SL-PRSs. With the first stage reservation 210a, a Rel. 18 Tx UE 120a-c indicates a reservation of the entire set of sub-channels while it may actually target to reserve just part of the resources within the set of sub-channels, i.e., one or more resources within the set of sub-channels for the one or more SL-PRS resources. The one or more SL-PRS resources are identified and reserved with the second stage reservation 210b. The second stage reservation 210b only needs to be received and interpreted by Rel. 18 UEs 120a-c, i.e., Tx UEs 120a-c performing mode 2 sensing to transmit SL-PRS and/or Rx UEs 120a-c of SL-PRS.

In an embodiment, the first stage assignment 210a may be sent in the 1^{st}-stage SCI carried in a PSCCH within a sub-channel. The first stage assignment 210a may be indicated with one of the up to two assignments within the 1^{st}-stage SCI that is used in legacy systems for the assignment of resources for a retransmission of a TB. The advantage of this is that backward compatibility can be ensured. In particular, the advantage of sending the first stage assignment 210a in a 1^{st}-stage SCI is that it can be interpreted by mode 2 sensing UEs (Rel. 16/17/18) 120a-d intending to transmit data without those UEs 120a-d requiring to understand that the reservation, i.e., assignment, is for SL-PRS. For Rel. 16/17 Tx UEs 120d performing mode 2 sensing (i.e., to transmit data), the first stage assignment 210a of a SL-PRS resource would be transparent, i.e. the UEs 120d do not need to know that these resources are reserved for SL-PRS. This is regardless of whether all the resources within the set of sub-channels are indeed assigned with a second stage assignment 210b or not.

In an embodiment, Rel. 18 Rx UEs 120a-c can be configured to interpret an assignment carried in a 1^{st}-stage SCI as a first stage assignment 210a of a SL-PRS resource, if the assignment is of a given number of sub-channels, e.g., an assignment of all the sub-channels of a resource pool in a future slot. In this case, it can be configured that only Rel. 18 UEs 120a-c are allowed to assign a given number of contiguous sub-channels, e.g., all the sub-channels in the RP, for assigning a SL-PRS resource. Furthermore, Rel. 18 Rx UEs 120a-c can be configured to interpret an assignment carried in a 1^{st}-stage SCI as a first stage assignment 210a of a SL-PRS resource, if the assignment is of a given set of sub-channels (referred below as semi-dedicated resources). In this case, it can be configured that only Rel. 18 UEs 120a-c are allowed to assign a given set of contiguous sub-channels. Rel. 18 Rx UEs 120a-c can also be configured to interpret an assignment carried in a 1^{st}-stage SCI as a first stage assignment 210a of a SL-PRS resource based on the presence of the second stage assignment 210b of the SL-PRS resource. Thus, according to an embodiment, only after a Rx UE 120a-c is aware of the presence of a second stage assignment 210b, it can know that an assignment in a 1^{st}-stage SCI is a first stage assignment 210a of a SL-PRS resource. If a UE 120a-c has determined that an assignment is a first stage assignment 210a, it proceeds to decode the second stage assignment 210b to determine the assigned SL-PRS resource(s).

In an embodiment, the second stage assignment 210b can be sent together with the first stage assignment 210a. In particular, the second stage assignment 210b can be sent within the sub-channel that also carries the associated first stage assignment 210a. This has the advantage that Rel. 18 UEs 120a-c, i.e., UEs 120a-c performing mode 2 sensing to transmit SL-PRS and/or Rx UEs 120a-c of SL-PRS, only need to check for the first stage and second stage assignments 210a,b in one sub-channel to determine the one or more assigned SL-PRS resources. In particular, the second stage assignment 210b can be sent in a 2^{nd}-stage SCI. The second-stage assignment 210b can also be sent within a PSSCH associated with the PSCCH that carries the first stage assignment 210a. The presence of a second stage assignment 210b within a sub-channel can be indicated based on the control information within the sub-channel. In particular, the presence of a second stage assignment 210b can be indicated with one of the reserved bits in the 1^{st}-stage SCI. In addition, it can also be indicated with the indication of a 2^{nd}-stage SCI format associated with SL-PRS. The 2^{nd}-stage SCI associated with the SL-PRS can carry the second stage assignment 210b and can be sent in the same sub-channel that carries the corresponding 1^{st}-stage SCI. The 2^{nd}-stage SCI associated with SL-PRS can also carry further information associated with a SL-PRS.

In an embodiment, the first stage and second stage assignment 210a,b may be sent by the UE 120a-c in a sub-channel in a slot prior to the assigned set of sub-channels, i.e., in a sub-channel of a previous slot. This has the advantage that the UEs 120a-c are aware of the assigned resources prior to the transmission of the SL-PRS.

In an embodiment, the sub-channel that carries the two-stage assignment can be used to send other related information associated with the assigned SL-PRS transmission or that is necessary to receive the assigned SL-PRS. This information can comprise configuration and parameters of the SL-PRS of each SL-PRS resource, e.g., the type of sequence used for the SL-PRS (e.g. Zaduff-Chu sequence, Gold sequence, etc.), the sequence identifier, the initialization of the sequence, a periodicity of the SL-PRS, resource repetition, the comb size, the staggering pattern, quasi-colocation information, parameters for power control of the SL-PRS transmission, and the like. This related information can be sent in the SCI (e.g., 2^{nd}-stage SCI) or in a PSSCH in the sub-channel that carries the two-stage assignment.

For a Rel. 18 Tx UE 120a-c sending the two-stage assignment, the resource allocation of the sub-channel may follow the conventional resource allocation procedures, i.e., mode 1 or mode 2. Furthermore, the resource allocation for a SL-PRS can also be based on mode 1 and mode 2 procedures adapted for SL-PRS, which will be described in more detail below.

In an embodiment, a priority of the reserved SL-PRS resource can be sent in the SCI (e.g., 2^{nd}-stage SCI) or in a PSSCH in the sub-channel that carries the two-stage reservation.

In an embodiment, the first stage and second stage assignment 210a,b may be sent by the UE 120a-c within the assigned set of sub-channels. This means that the first and second stage assignment are sent within the semi-dedicated resource that includes the SL-PRS resource indicated by the two-stage assignment. The first stage and second stage assignment are then sent in the same slot as the SL-PRS. This has the advantage that the UE 120a-c can receive a SL-PRS and the associated first and second stage assignment in the same slot. In addition, the source and destination ID of the SL-PRS can also be sent within the assigned set of sub-channels. Sending a SL-PRS with the associated first stage and second stage assignment in the same slot, i.e., within the assigned sub-channels, can be considered for a shared resource pool as well as for a dedicated resource pool.

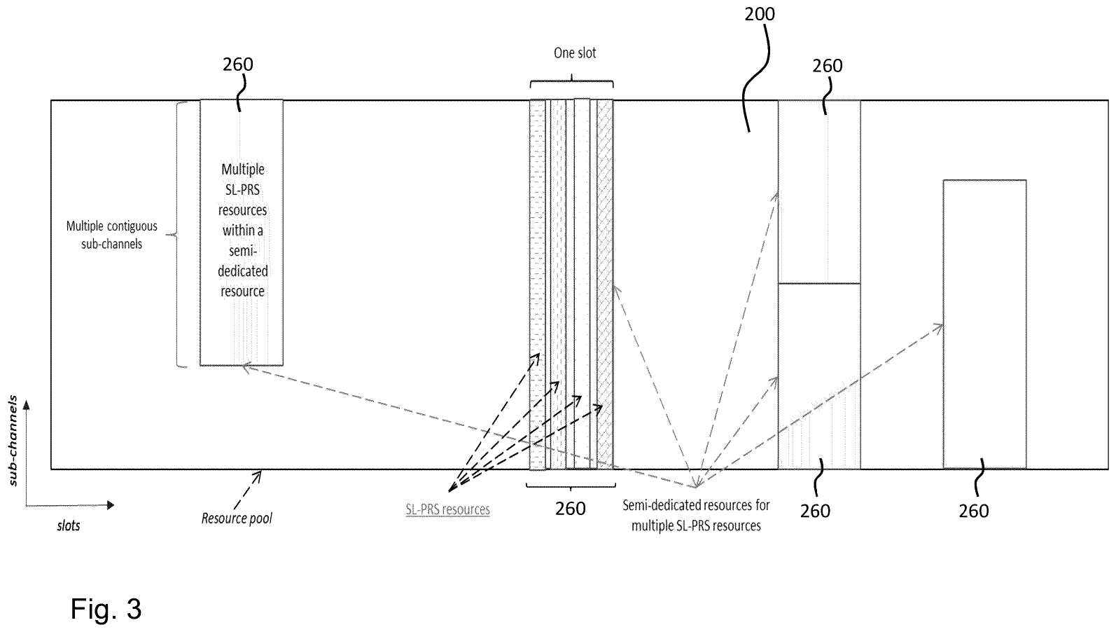

In an embodiment, the set of sub-channels reserved by a first stage assignment 210a can correspond to a semi-dedicated resource 260 for SL-PRS. As used herein, a semi-dedicated resource 260 for SL-PRS may correspond to a (pre-)configured set of sub-channels in (pre-)configured slots within a resource pool, as illustrated in FIG. 3. Multiple SL-PRS resources can be (pre-)configured within a semi-dedicated resource 260, as illustrated in FIG. 3. FIG. 3 shows examples of SL-PRS resources in one symbol. A SL-PRS resource within a semi-dedicated resource 260 may span multiple symbols and may span the set of sub-channels in a comb pattern or structure. Multiple SL-PRS resources may be multiplexed within a semi-dedicated resource 260. Multiple semi-dedicated resources 260 for SL-PRS may be (pre-)configured within a resource pool. The advantage of the (pre-)configuration of semi-dedicated resources 260 is that it allows Rel. 18 UEs 120a-c to have a common understanding about SL-PRS resources. In particular, it allows UEs 120a-c, i.e., Rel. 18 UEs, to know the set of sub-channels where SL-PRS can be sent, as well as to know the configuration of the SL-PRS resources (i.e. time/frequency allocation of a SL-PRS resource) within the set of sub-channels, i.e. within a semi-dedicated resource 260. In particular, semi-dedicated resources 260 may be (pre-)configured within a shared resource pool. This has the advantage that the sub-channels within the semi-dedicated resources can be considered for SL-PRS in a shared resource pool.

In an embodiment, different number of sub-channels can be (pre-)configured for different semi-dedicated resources 260, e.g., to support SL-PRS resources with different bandwidths, as illustrated in FIG. 3. More specifically, a semi-dedicated resource 260 may comprise all the sub-channels in a slot of a resource pool. This has the advantage that a SL-PRS resource may occupy the entire bandwidth of the resource pool.

In an embodiment, the semi-dedicated resources 260 may be configured by the network 110, i.e. the base station 110, e.g., when the UE 120a-c is in network coverage or can be pre-configured for out of network coverage. The configuration by the network 110, i.e. the base station 110 has the advantage that the configuration of the semi-dedicated resources 260 can be adapted by the network 110, i.e. base station 110, e.g., depending on the traffic load and request for SL-PRS resources. The pre-configuration has the advantage that semi-dedicated resources 260 can be used in out of network coverage situations. In an embodiment, the semi-dedicated resources 260 may also be configured dynamically, i.e., among a group of UEs 120a-c. This would allow the UEs 120a-c within the group to have a common understanding of the SL-PRS resources within the group.

In an embodiment, the semi-dedicated resources 260 only need to be (pre-)configured for Rel. 18 UEs 120a-c, as only Rel. 18 UEs 120a-c need to be aware of the semi-dedicated resources 260 for SL-PRS. For Rel. 16/17 UEs 120d, the semi-dedicated resources 260 are transparent and correspond to normal sub-channels like other sub-channels in the resource pool. The allocation of SL-PRS resources can be performed based on mode 1 or mode 2. In mode 1, the network 110, i.e. the base station 110 can allocate resources within the semi-dedicated resources 260 for SL-PRS or for data transmissions, e.g., depending on request. If resources are allocated for SL-PRS, the network 110, i.e. the base station 110 can indicate which SL-PRS resource can be used by a given Tx UE 120a-c. In mode 2, a Rel. 16/17 Tx UE 120d can use a sub-channel within a semi-dedicated resource 260, if it has sensed it to be free. In mode 2, a Rel. 18 Tx UE 120a-c can use a SL-PRs within a semi-dedicated resource 260, if it has sensed it to be free. Due to the two-stage reservation of SL-PRS resources, the mode 2 sensing procedure for finding a SL-PRS resource may be enhanced to support the selection of a SL-PRS resource, as described in more detail below in the context of different more detailed embodiments.

The reservation, i.e., assignment, of a SL-PRS resource within a semi-dedicated resource 260 is indicated with the two-stage reservation sent in a sub-channel sent in a slot prior to the slot with the semi-dedicated resource 260. With embodiments disclosed herein there is no need to send SCI or other related information required to receive a SL-PRS within a semi-dedicated resource 260. The information required to receive a SL-PRS can be sent within the sub-channel that carries the corresponding two-stage reservation. The advantage of not having any SCI or other information related to a SL-PRS within the semi-dedicated resources 260 is that all the resources within a semi-dedicated resource 260 can be used for SL-PRS resources. If a semi-dedicated resource 260 spans all the sub-channels in a slot of a resource pool, the entire slot can be used for SL-PRS resources, e.g., 12 SL-PRS resources plus and automatic gain control (AGC) symbol and a guard symbol. If SCI or other information related to a SL-PRS is multiplexed with SL-PRS in non-overlapping resources within a semi-dedicated resource 260, i.e., in a 1^{st}-stage SCI carried in a PSCCH within the semi-dedicated resources 260, this may lead to reduced resources for SL-PRS, e.g., a smaller number of SL-PRS resources within a semi-dedicated resource 260. In addition, if SCI or other information related to a SL-PRS is multiplexed with SL-PRS in overlapping resources within a semi-dedicated resource 260, this may impact the positioning estimation with the SL-PRS. In this regard, multiplexing a 2^{nd}-stage SCI with SL-PRS resources may not be desired, i.e. within a semi-dedicated resource 260. However, in the embodiments disclosed herein SCI associated with a SL-PRS could be sent within a semi-dedicated resource 260, e.g., at the expense of reduced resources available for SL-PRS. The SCI can be sent in a PSCCH. This can be considered to have SCI sent along with a SL-PRS transmission on the same slot, similar to how SCI is sent along with a data transmission in one or more sub-channels.

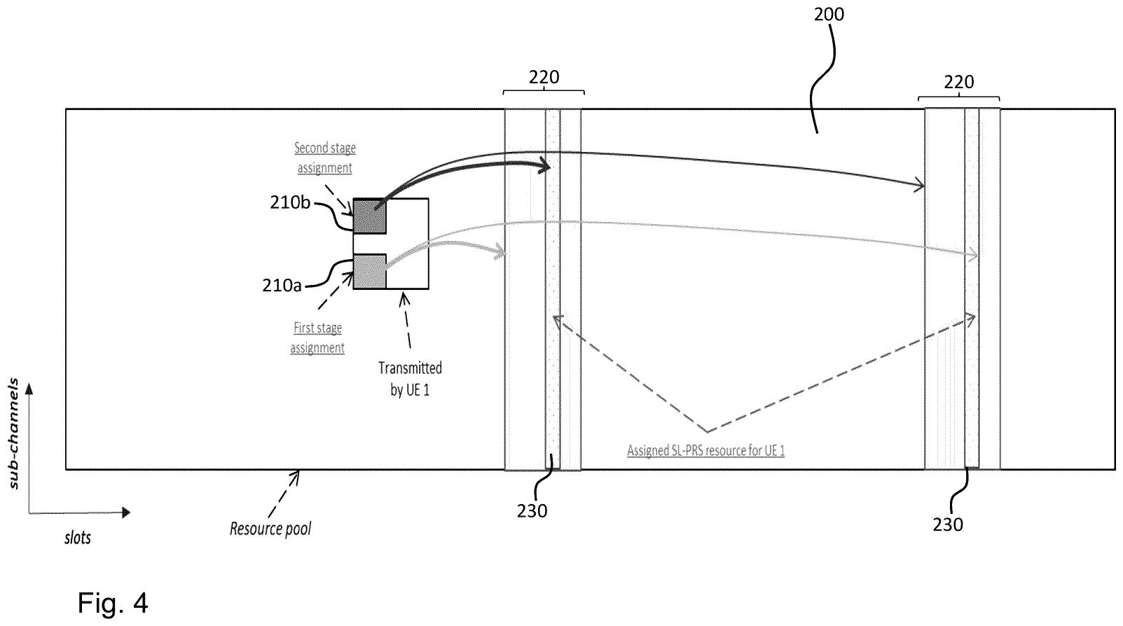

Multiple first stage assignments, i.e. reservations can also be sent to indicate the assignment of multiple semi-dedicated resources 260. Two first stage assignments 210a, 210a′ can be indicated with the two assignments within the 1^{st}-stage SCI that can be used in legacy systems for the assignment of resources for two retransmissions of a TB. Multiple first stage assignments can also be indicated by assigning multiple semi-dedicated resources 260 with a period. Multiple first stage assignments 210a, 210a′ of multiple semi-dedicated resources 260 with a period can be indicated with the RRI sent within the 1^{st}-stage SCI carried in PSCCH, that is used in legacy systems for the indication of periodic reserved resources for the transmission of future TBs. Furthermore, the second stage assignment 210b may also indicate multiple SL-PRS resources at different reserved semi-dedicated resources 260. An example of the two-stage assignment for multiple semi-dedicated resources is depicted in FIG. 4. For each first stage assignment 210a, 210a′ the second stage assignment 210b, 210b′ may or may not be the same. For example, for reserved semi-dedicated resources 260 with a period, the second stage assignment 210b, 210b′ may be the same, i.e., the reserved SL-PRS resource within semi-dedicated resources 260 is the same (see example in FIG. 4). For each first stage assignment 210a, 210a′ there may be a second stage assignment 210b, 210b′, i.e., when the reserved semi-dedicated resources 260 span a different number of sub-channels a different second stage assignment 210b, 210b′ may be needed to indicate a different SL-PRS resource reserved in each semi-dedicated resource 260.

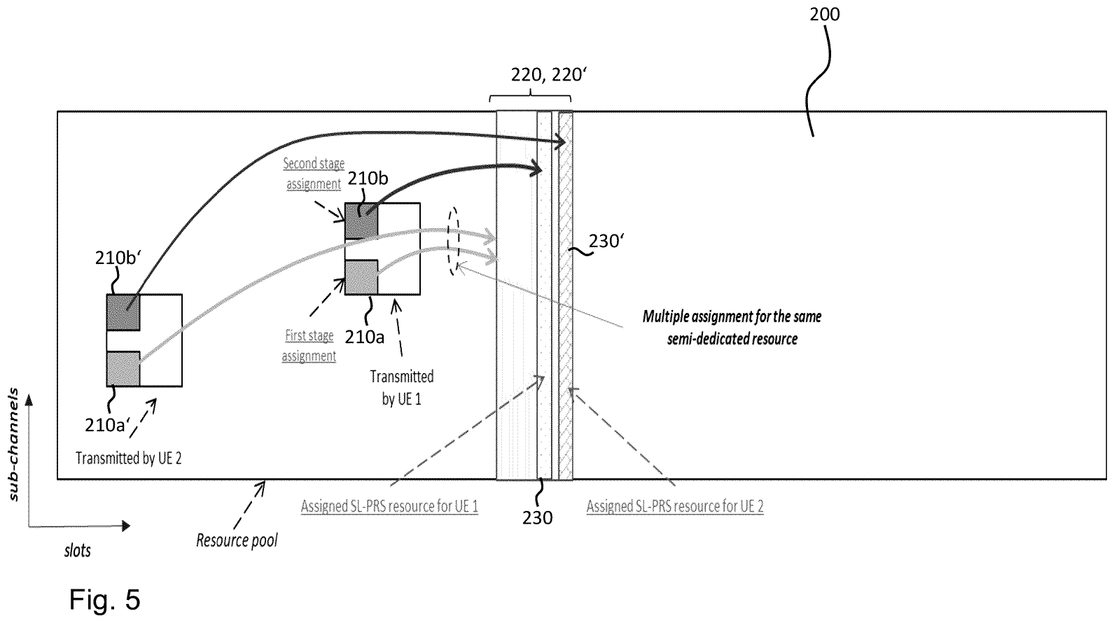

If multiple Rel. 18 Tx UEs 120a-c assign, i.e. reserve different SL-PRS resources within a semi-dedicated resource 260, the multiple Rel. 18 Tx UEs 120a-c may send the first stage assignment 210a, 210a′ for the same semi-dedicated resource 260 as illustrated in FIG. 5. More specifically, as illustrated in FIG. 5, the first and second stage assignment 210a,b of a first two-stage assignment may assign the first and second resources 220, 230, while the first and second stage assignment 210a′,b′ of a further two-stage assignment may assign the first and second resources 220′, 230′. As multiple assignments for the same set of sub-channels may be sent, this increases the likelihood that the semi-dedicated resources 260 are used for SL-PRS transmissions and not for data transmissions. If one or more sub-channels within the semi-dedicated resources 260 have been assigned by another UE 120b,c, a Rel. 18 Tx UE 120a may pre-empt the one or more sub-channels with the assignment of one or more SL-PRS within the semi-dedicated resources 260. In this case, the priority of SL-PRS transmission may be (pre-)configured to be higher than the data transmission of the other UEs to enable the pre-emption mechanism as detailed in the embodiments.

The set of sub-channels is referred to as semi-dedicated resources as they can be used both for data transmissions and SL-PRS transmissions, i.e., they are not entirely dedicated to SL-PRS. However, embodiments disclosed herein enable the use of those resources for the transmission of SL-PRS. In addition, embodiments disclosed herein allow UEs 120a-c to have a common understanding of the SL-PRS resources within the semi-dedicated resources.

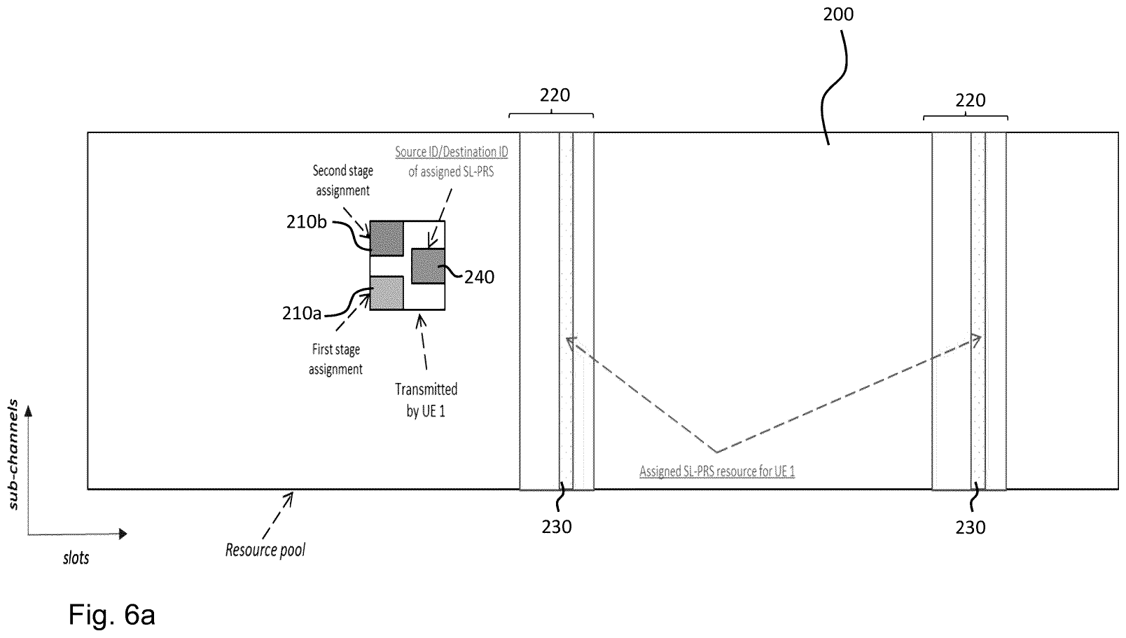

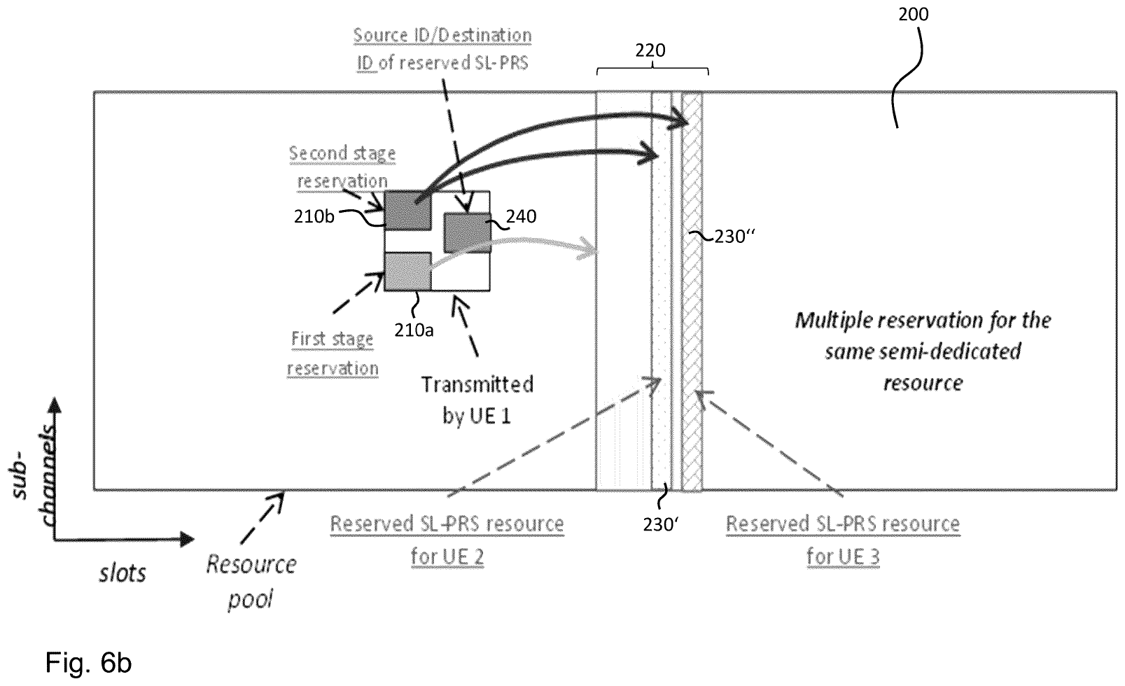

Moreover, according to embodiments disclosed herein a source ID and a destination ID of a SL-PRS transmission may be send within the same sub-channel that carries the first and second stage assignment 210a,b, as illustrated in FIG. 6a. More specifically, the source ID/destination ID may be carried in the 2^{nd}-stage SCI within the sub-channel that carries the two-stage assignment. The source ID is an identifier of the UE that sends a transmission, i.e., a transmission of a SL-PRS. The destination ID is an identifier of the UE(s) that is an intended receiver(s) of a transmission, i.e., of transmission of a SL-PRS. The destination ID may be checked by Rel. 18 Rx UEs 120a-c, to determine whether they are target recipients of the assigned SL-PRS resource to be transmitted within a semi-dedicated resource 260. Sending the source ID and destination ID within the sub-channel where the two-stage assignment is sent allows a Rel. 18 Rx UE 120a-c to be aware in advance whether it is a target Rx UE of a SL-PRS in a semi-dedicated resource 260 or not.

In case of multiple first stage and second stage assignments, a destination ID and source ID for each first stage and second stage assignment may be provided. For multiple first stage and second stage assignments, the destination ID and source ID can be the same. In addition, the UE 120a-c sending the two-stage assignment of a SL-PRS resource may or may not be the same UE 120a-c that sends the SL-PRS resource. Thus, the destination ID may be an identifier of a UE 120a-c that is different than the UE 120a-c that sends the two-stage assignment. This has the advantage that a UE 120a-c can send the reservation of a SL-PRS resource that shall be sent by another UE 120a-c.

A variant of the embodiment shown in FIG. 6a is illustrated in FIG. 6b, where the first UE 120a sends the two-stage reservation for SL-PRS resources that shall be transmitted by the second UE 120b and the third UE 120c. More specifically, by means of the two-stage assignment illustrated in FIG. 6b the first UE 120a reserves the second resources 230′ for the second UE 120b and the second resources 230″ for the third UE 120c. In this embodiment, the UEs 120a-c may be part of a group of a UEs. The first UE 120a may be the group leader and obtain resources for the SL-PRS transmissions of the UEs 120a-c in the group.

As already described above, the UEs 120a-c disclosed herein may include among others hand-held terminal devices and in-vehicle devices, which communicate with each other in the SL of the wireless communication network 100 and can transmit and receive a reference signal in the sidelink for positioning. Moreover, as already described above, one object of the present disclosure is to enable sharing the resources within a resource pool for data transmission and SL-PRS transmissions with different granularities.

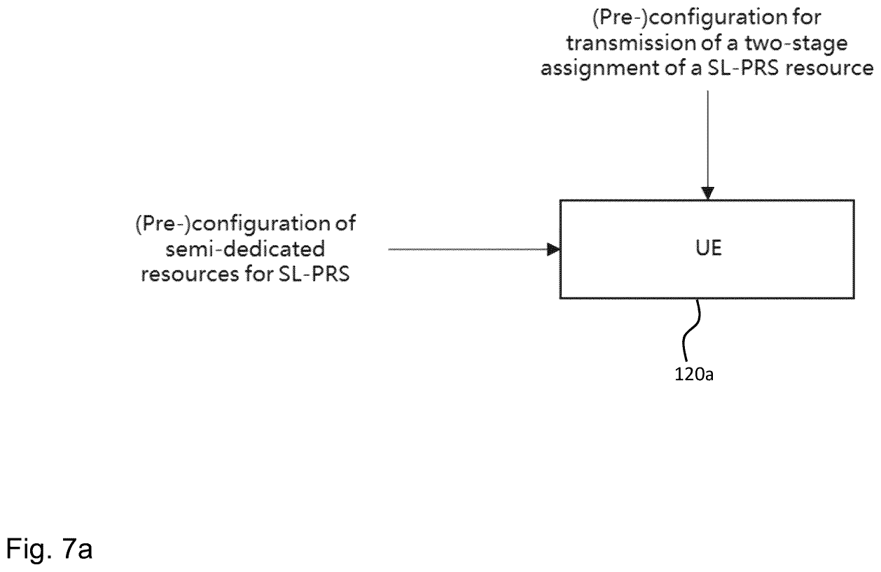

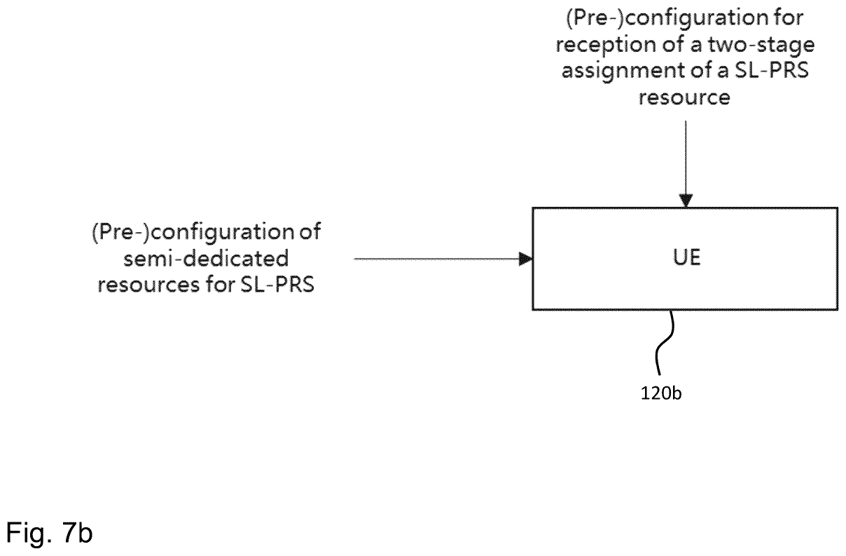

A first main embodiment is shown in FIG. 7a, with the (pre-)configuration of a UE 120a-c for semi-dedicated SL-PRS resources 260 and for the transmission of a two-stage assignment of SL-PRS resources. The configuration can be provided by the network 110, i.e. the base station 110 or by another UE 120a-c or it can be preconfigured within the UE 120a-c. The (pre-)configuration of the semi-dedicated resources 260 may comprise the (pre-)configuration and indication of the slots in a resource pool with semi-dedicated resources 260, as well as the frequency resource location, i.e., the starting sub-channel index and number of contiguous sub-channels, for each of the semi-dedicated resources 260. In addition, the (pre-)configuration may comprise a periodicity of the semi-dedicated resources 260. Furthermore, the (pre-)configuration may comprise the (pre-)configuration of the SL-PRS resources within each sub-channel, i.e., how many SL-PRS resources there are in each semi-dedicated resource 260, as well as the time and frequency allocation of each SL-PRS resource within a semi-dedicated resource 260. The (pre-)configuration may also include the parameters of the SL-PRS for each SL-PRS resource, e.g., the type of sequence used for the SL-PRS (e.g. Zaduff-Chu sequence, Gold sequence, etc.), the sequence identifier, a parameter for the initialization of the sequence, a periodicity of the SL-PRS, resource repetition, the comb size, the staggering pattern, quasi-colocation information, parameters for power control of the transmission of a SL-PRS, and the like. The (pre-)configuration of the semi-dedicated resources, allows UEs 120a-c, i.e., Rel. 18 UEs, to have a common understanding of the SL-PRS resources in a shared resource pool. In particular, the (pre-)configuration of the semi-dedicated resources 260 allows a UE 120a-c to be aware of the resources on which it can send a SL-PRS. A (pre-)configured semi-dedicated resource 260 can consist of all the sub-channels in a slot within a resource pool. In particular, all (pre-)configured semi-dedicated resources 260 may each span all the sub-channels of a resource pool.

FIG. 7a further shows the (pre-)configuration for the transmission of a two-stage assignment. This (pre-)configuration indicates to a UE 120-c how it shall transmit the first stage 210a and second stage 210b assignment of a SL-PRS resource. The (pre-)configuration of the two-stage assignment may consist of the indication 240 where and how the first stage 210a and second stage assignment 210b shall be sent, i.e., the location within a sub-channel. The (pre-)configuration may indicate that a UE 120a-c shall transmit the first stage assignment 210a in a 1^{st}-stage SCI carried in a PSCCH. The (pre-)configuration may comprise an indication 240 that a UE 120a-c that reserves a SL-PRS resource can only send first stage assignment(s) 210a of one or more semi-dedicated resources 260. The (pre-)configuration may consist of an indication 240 that a UE 120a-c that assigns a SL-PRS resource shall indicate the presence of a second stage assignment 210b of the SL-PRS resource with one of the reserved bits in a 1^{st}-stage SCI. The (pre-)configuration may consist of an indication 240 that a UE 120a-c that assigns a SL-PRS resource shall indicate the presence of a second stage assignment 210b of the SL-PRS resource with the indication in a 1^{st}-stage SCI of a 2^{nd}-stage SCI format associated with the SL-PRS. The (pre-)configuration may indicate that a UE 120a-c shall transmit the second stage assignment in a 2^{nd}-stage SCI. The 2^{nd}-stage SCI can be associated with the 1^{st}-stage SCI which carries the first stage assignment 210a. The (pre-)configuration may indicate that a UE 120a-c shall send the first and second stage assignment 210a,b together in one sub-channel. Based on the (pre-)configuration for the transmission of the two-stage assignment, a UE 120a-c is then aware of how to transmit a two-stage assignment for SL-PRS resources.

A second main embodiment is shown in FIG. 7b, with the (pre-)configuration of a UE 120a-c for the semi-dedicated resources 260 and for the reception of a two-stage assignment of SL-PRS resources. The configuration can be provided by the network 110 or it can be preconfigured within the UE 120a-c. The (pre-)configuration of the semi-dedicated resources 260 corresponds to the (pre-)configuration of the semi-dedicated resources 260 previously described in the context of the first main embodiment. The (pre-)configuration of the semi-dedicated resources 260, allows the UEs 120a-c to have a common understanding of the SL-PRS resources in a shared resource pool. In particular, the (pre-)configuration of the semi-dedicated resources 260 allows a UE 120a-c to be aware of the resources on which it can receive a SL-PRS.

FIG. 7b further show the (pre-)configuration for the reception of a two-stage assignment. This (pre-)configuration indicates to a UE 120a-c where to find and how it shall determine the first stage 210a and second stage 210b assignment of SL-PRS resources, i.e., their location within a sub-channel. The (pre-)configuration may indicate that a first stage 210a and second stage 210b assignment are sent together, e.g., in one sub-channel. The (pre-) configuration may indicate that a first stage assignment 210a can be located in a 1^{st}-stage SCI carried in a PSCCH. The (pre-)configuration may indicate that an assignment of one or more semi-dedicated resources 260 corresponds to first stage assignments(s) 210a of SL-PRS(s). The (pre-)configuration may consist of an indication that the UE 120a-c shall interpret a resource assignment in a 1^{st}-stage SCI as the first stage assignment 210a of SL-PRS resource(s) based on the presence of a second stage assignment 210b of the SL-PRS resource(s). The (pre-)configuration may indicate that the presence of a second stage assignment 210b of SL-PRS(s) can be indicated with one of the reserved bits in the 1^{st}-stage SCI or with the indication in the 1^{st}-stage SCI of a 2^{nd}-stage SCI format associated with the SL-PRSs. The (pre-)configuration may also indicate that the presence of a second stage assignment 210b may be indicated with the assignment in a 1^{st}-stage SCI of a given number of sub-channels or with an assignment in a 1^{st}-stage SCI of a semi-dedicated resource 260. In this case, in an embodiment, it can be configured that only Rel. 18 UEs 120a-c are allowed to assign a given number of contiguous sub-channels, e.g., all the sub-channels in the RP, for assigning SL-PRS resource(s). Legacy UEs 120d are then configured to not assign more than the given number of sub-channels for a data transmission. The (pre-)configuration may also indicate that the second stage assignment 210b is located in a 2^{nd}-stage SCI. In particular, the 2^{nd}-stage SCI may be associated with the 1^{st}-stage SCI that carries the first stage assignment 210a. Based on the (pre-)configuration for the reception of the two-stage assignment, a UE 120a-c is then aware of how to receive a two-stage assignment for SL-PRS resource(s), and consequently it is aware of where to receive the SL-PRS.

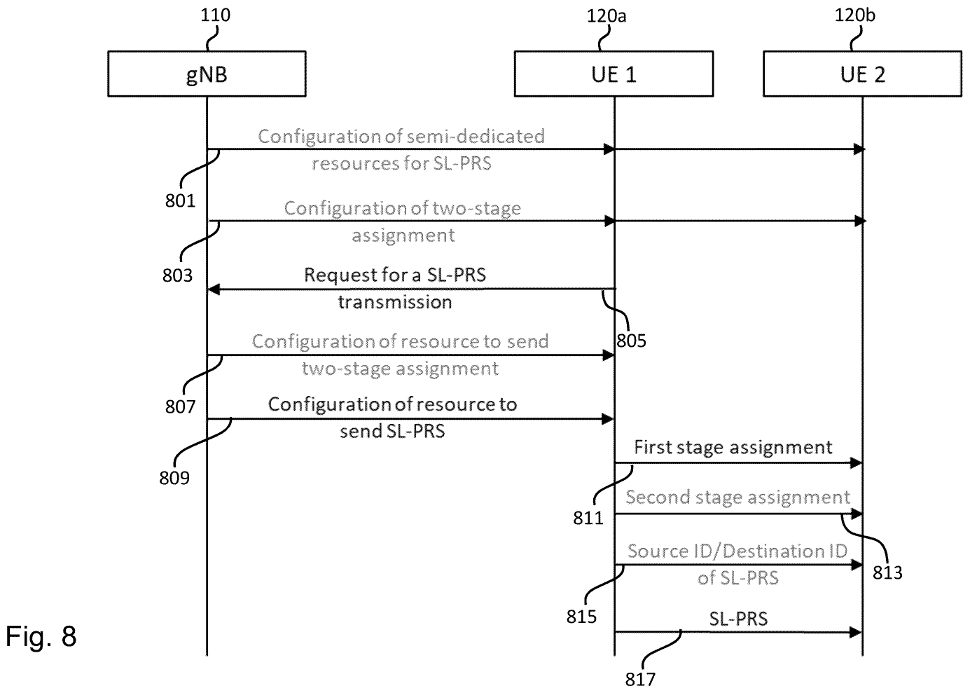

A third main embodiment is shown in FIG. 8, for a scenario in network coverage, with the base station or gNB 110 providing to the UEs 120a-d the configuration of the semi-dedicated resources 260 for SL-PRSs and for the two-stage assignment. In an embodiment, both configurations can be provided only to Rel. 18 UEs 120a-c, i.e., legacy UEs 120d are not aware about the configuration related to SL-PRSs. This means that the configurations can be release specific. In FIG. 8 the first UE 120a (UE 1) and the second UE 120b (UE 2) are assumed to be Rel. 18 UEs. The configuration of the semi-dedicated resources 260 for SL-PRS and for the two-stage assignment may be included within the information element which specifies the configuration information for a resource pool (e.g., SL-ResourcePool), which is signaled to the UEs 120a,b by the network.

If the gNB 110 has configured a resource pool for sidelink communication, i.e., for data transmissions in the sidelink, the gNB 110 may configure the resource pool also for SL-PRS transmission. The resource pool becomes a shared pool for sidelink communication and SL-PRS transmissions. The configuration that the resource pool is a shared resource pool may only be done for the Rel. 18 UEs 120a-c. The configuration that a resource pool is a shared resource pool may correspond to the configuration of the semi-dedicated resources 260 for SL-PRS and/or for the two-stage assignment. Thus, when Rel. 18 UEs 120a-c are provided with the configuration of the semi-dedicated resources 260 for SL-PRS and/or for the two-stage assignment, they are aware that the resource pool is a shared resource pool. The configuration of the semi-dedicated resources 260 for SL-PRS and for the two-stage assignment may be provided to the Rel. 18 UEs 120a-c and afterwards the gNB 110 may provide an additional configuration to configure the resource pool to be a shared resource pool. Legacy UEs 120d are not aware of the shared resource pool.

As shown in step 801 of FIG. 8, the gNB 110 provides the configuration of the semi-dedicated resources 260 to the Rel. 18 UEs, e.g., the first UE 120a and the second UE 120b (step 801 of FIG. 8). The configuration comprises the configuration and indication of the semi-dedicated resources 260 as previously described in the context of the first main embodiment above. The configuration of the semi-dedicated resources 260 provided to the UEs 120a-c, allows the UEs 120a-c to have a common understanding of the SL-PRS resources in the shared resource pool. In particular, the configuration of the semi-dedicated resources 260 allows a Tx UE, for instance, the UE 120a to be aware of the resources on which it can send a SL-PRS and allows a Rx UE, for instance, the UE 120b to be aware of the resources on which it can receive a SL-PRS.

In addition, the gNB 110 provides the configuration of the two-stage assignment to the Rel. 18 UEs 120a-c (step 803 of FIG. 8). This configuration comprises the configuration for the transmission and reception of the two-stage assignment. This configuration indicates to a Tx UE, for instance, the UE 120a where and how it shall transmit the first stage and second stage assignment 210a,b of a SL-PRS resource, i.e., within a sub-channel, and indicates to a Rx UE, for instance, the UE 120b where to find and how it shall determine the first stage and second stage assignment 210a,b of a SL-PRS resource. The configuration of the two-stage assignment corresponds to the configuration of the two-stage assignment for transmission and reception previously described in the context of the first and second main embodiments, respectively. In particular, it can be configured that only Rel. 18 UEs 120a-c are allowed to reserve a given number of contiguous sub-channels, e.g., all the sub-channels in the RP, for reserving a SL-PRS resource. Legacy UEs 120d can be configured to reserve for a transmission up to the given number of sub-channels minus one, i.e., legacy UEs 120d are not allowed to reserve the given number of sub-channels for a transmission. Rel. 18 UEs 120a-c can also be configured to interpret a reservation of the given number of sub-channels as a first stage reservation 210a of a SL-PRS and then to search for the second stage reservation 210b within the same sub-channel to determine the reserved SL-PRS resource(s) within the reserved given number of sub-channels.

In the exemplary embodiment shown in FIG. 8 it is assumed that the UEs 120a,b are configured to send/receive the first stage reservation 210a and the second stage reservation 210b in a 1^{st}-stage SCI and 2^{nd}-stage SCI, respectively. The UEs 120a,b are also configured such that the presence of a second stage reservation 20b is indicated with the indication of a 2^{nd}-stage SCI format associated with SL-PRS. Based on the presence of a 2^{nd}-stage SCI associated with SL-PRS, a UE 120a,b is aware that the reservation carried in a 1^{st}-stage SCI corresponds to the first stage reservation 210a of a SL-PRS resource.

Due to the availability of the network coverage, the resource selection of a SL-PRS resource can be done with mode 1 resource allocation. The resource selection can also be performed with mode 2 resource allocation when in network coverage. In the embodiment depicted in FIG. 8, the SL-PRS resource is selected based on mode 1 resource allocation. In this case, the first UE 120a requests resources from the gNB 110 for the transmission of a SL-PRS (step 805 of FIG. 8). The first UE 120a could also obtain the resources based on autonomous resource selection, e.g., with mode 2. The first UE 120a may also provide further related information that enables the gNB 110 to determine an appropriate resource for the SL-PRS, i.e., positioning requirements, bandwidth requirement of the SL-PRS, and the like. The gNB 110 provides the configuration of a resource (i.e., one sub-channel) to the first UE 120a (step 807 of FIG. 8) in order for the first UE 120a to send the two-stage reservation on that resource. The configuration may comprise the time and frequency allocation of the resource. The gNB 110 provides the resource(s) for SL-PRS to the first UE 120a (step 809 of FIG. 8), indicating which SL-PRS resource(s) on which semi-dedicated resource(s) 260 the first UE 120a shall use for its SL-PRS transmission(s).

After the gNB 110 has provided the configuration of the resources for the two-stage reservation and the associated SL-PRS, the first UE 120a sends the first stage and second stage reservation 210a,b, i.e., together in the configured resource (steps 811 and 813 of FIG. 8). More specifically, the first UE 120a sends the first stage reservation 210a in the 1^{st}-stage SCI and the second stage reservation 210b in the associated 2^{nd}-stage SCI, where the format of the 2^{nd}-stage SCI is associated with SL-PRS. Within the 2^{nd}-stage SCI carried in the resource, the first UE 120a also may send the source ID and destination ID of the SL-PRS within the 2^{nd}-stage SCI (step 815 of FIG. 8). The second UE 120b receives the two-stage reservation and the source ID and destination ID of the SL-PRS. The second UE 102b is configured to interpret the two-stage reservation of the SL-PRS based on the configuration provided by the gNB 110.

The second UE 120b is also aware of the SL-PRS resource within a semi-dedicated resource 260, where it shall receive a SL-PRS. Afterwards, the first UE 120a sends the SL-PRS on the configured SL-PRS resource (step 817 of FIG. 8). The second UE 120b receives the SL-PRS sent by the first UE 120a. Other UEs 120c can be configured to send SL-PRS on other SL-PRS resources within the semi-dedicated resource on which the first UE 120a sends the SL-PRS.

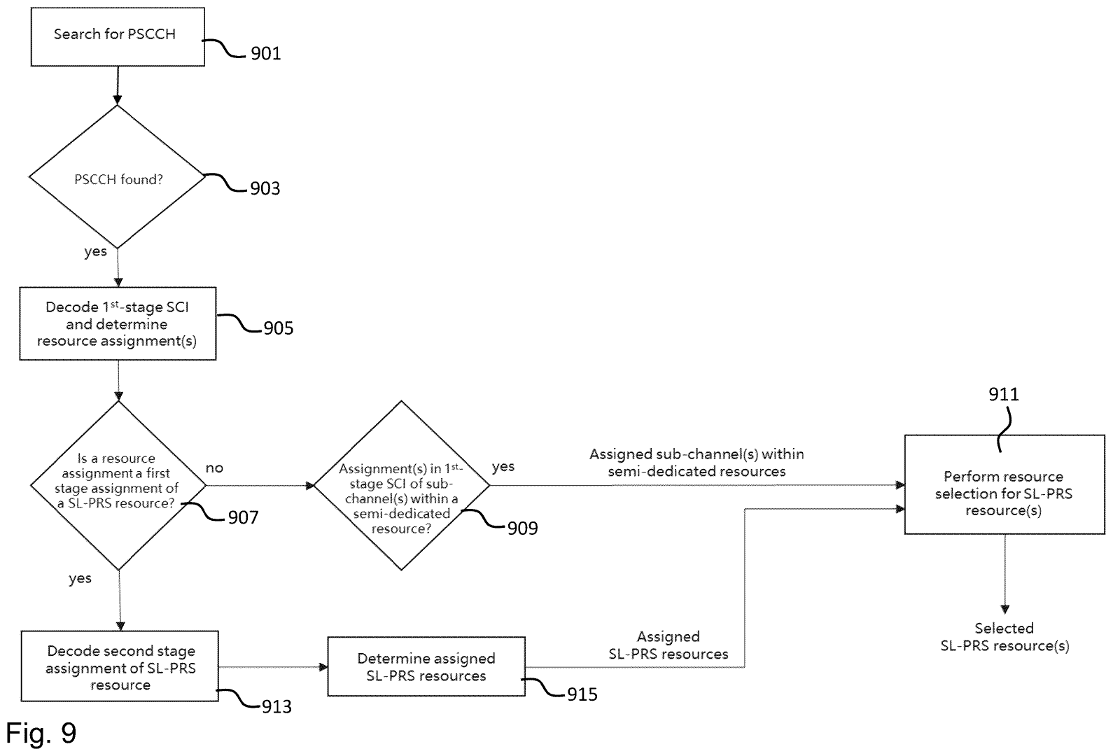

FIG. 9 shows a flow diagram illustrating a fourth main embodiment based on mode 2 resource allocation for a SL-PRS resource. More specifically, FIG. 9 illustrates steps for the selection of a SL-PRS resource based on the mode 2 sensing procedure with a two-stage reservation. The complete procedure applies only to Rel. 18 UEs 120a-c, as legacy UEs 120d are not aware of SL-PRS within the resource pool.

A UE 120a-c first searches for a PSCCH (step 901 of FIG. 9). Similar to the legacy mode 2 sensing, i.e., to the mode 2 sensing procedure in Rel. 16 and Rel. 17, a UE 120a-c can search for a PSCCH at all potential locations of a PSCCH in each sub-channel in the slots of a resource pool, e.g., in the slots of a sensing window. The presence of a PSCCH can be detected based on the PSCCH DMRS. If a PSCCH is found (step 903 of FIG. 9), the UE 120a-c decodes the 1^{st}-stage SCI carried by the PSCCH and determines the resource reservation(s) indicated by the 1^{st}-stage SCI (step 905 of FIG. 9). The UE 120a-c then needs to determine whether an indicated resource reservation is for a data transmission or for a SL-PRS transmission. The UE 120a-c checks whether a resource reservation indicated by a 1^{st}-stage SCI corresponds to a first stage reservation 210a of a SL-PRS resource (step 907 of FIG. 9). This may be determined in different ways. A UE 120a-c may determine that a resource reservation of a given number of sub-channels corresponds to a first stage reservation 210a of a SL-PRS resource. A UE 120a-c may also determine that a resource reservation of a semi-dedicated resource 260 corresponds to a first stage reservation 210a of a SL-PRS. A UE 120a-c may also determine that a resource reservation is a first stage reservation 210a based on the presence of a second stage reservation 210b. The presence of a second stage reservation 210b may be indicated with one of the reserved bits in the 1^{st}-stage SCI or with the indication of a 2^{nd}-stage SCI format associated with SL-PRS.

If the UE 120a-c detects a first stage reservation 210a of a SL-PRS resource, it proceeds to decode the second stage reservation 210b of the SL-PRS resource (step 913 of FIG. 9). The UE 120a-c is aware where and how to find the second stage reservation 210b based on (pre-)configuration. The second stage reservation 210b may be carried in the same sub-channel that carries the first stage reservation 210a. In particular, the second stage reservation 210b may be carried in the 2^{nd}-stage SCI associated with the 1^{st}-stage SCI. After decoding the second stage reservation 210b, the UE 120a-c determines reserved SL-PRS resources (step 915 of FIG. 9).

If a resource reservation(s) indicated by the 1^{st}-stage SCI does not correspond to a first stage reservation 210a, the UE 120a-c then checks whether the resource reservation indicates the reservation of sub-channel(s) within a semi-dedicated resource 260 for SL-PRS (step 909 of FIG. 9). The resource reservation may also be based on a periodicity for reserved resources, i.e., based on an RRI. In this way, the UE 120a-c may determine reserved sub-channel(s) within semi-dedicated resources.

Based on the resource reservations within semi-dedicated resources 260, i.e., of SL-PRS resources or of sub-channel(s) within semi-dedicated resource(s), the UE 120a-c can then perform resource selection for a SL-PRS resource (step 911 of FIG. 9). For this purpose, it can perform resource exclusion based on the resource reservations within semi-dedicated resources 260.

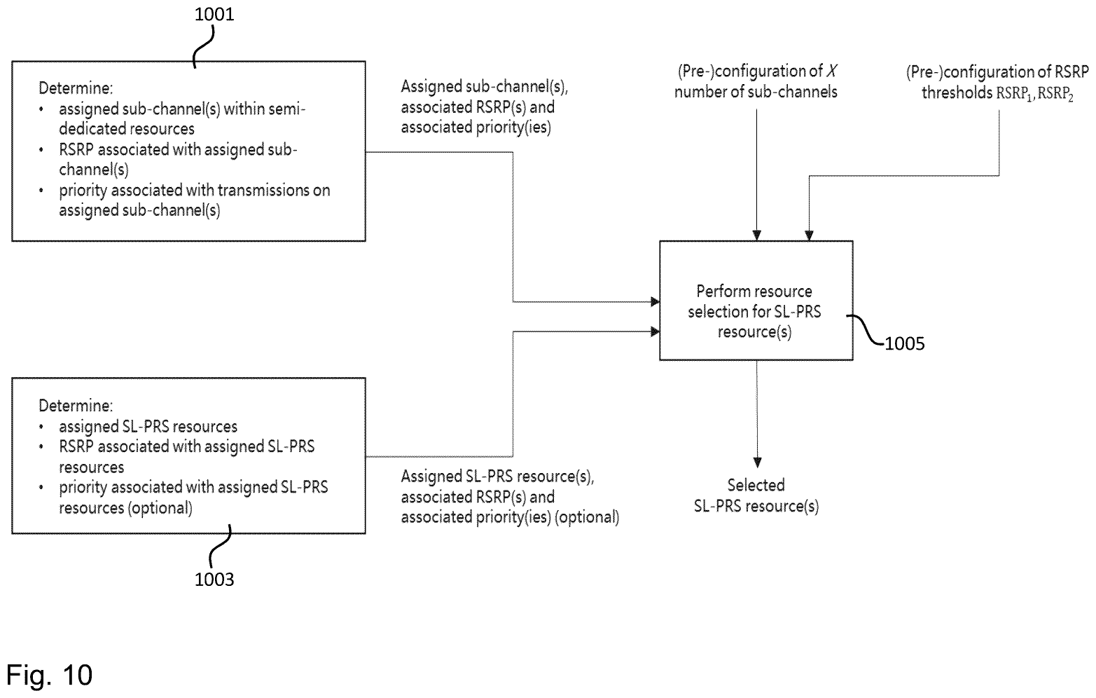

FIG. 10 illustrates a further embodiment for the mode 2 sensing procedure at a UE 120a-c, i.e., for a Rel. 18 UE, for selecting resources for SL-PRS. As illustrated in step 1001 of FIG. 10, a UE 120a-c may determine reservations of sub-channel(s) within semi-dedicated resources e.g., based on the procedure previously described in the context of the fourth main embodiment. The reserved sub-channels may be indicated in a 1^{st}-stage SCI that is carried in a PSCCH received by the UE 120a-c. The UE 120a-c also determines RSRP(s) associated with reserved sub-channel(s). The RSRP may be measured based on the DMRS within the PSCCH that carries the 1^{st}-stage SCI that indicates the reserved sub-channels(s). This RSRP(s) are to be considered for the exclusion of resources in the mode 2 sensing procedure. The UE 120a-c is (pre-)configured to measure the RSRP associated with a resource reservation based on the PSCCH DMRS of the PSCCH that carries the 1^{st}-stage SCI that indicates the resource reservation. In particular, the (pre-)configuration to measure the RSRP based on PSCCH DMRS for resource selection can be part of the (pre-)configuration of the resource pool. In this case, all UEs 120a-c using the resource pool may measure the RSRP associated with a resource reservation based on the PSCCH DMRS of the corresponding PSCCH. The (pre-)configuration may be indicated with a higher layer parameter, i.e., sl-RS-ForSensing. The (pre-)configuration may be indicated within the (pre-)configuration of the SL-ResourcePool information element, i.e., by setting the parameters sl-RS-ForSensing-r16 to pscch. In addition, the UE 120a-c may determine a priority associated with transmissions on the reserved sub-channel(s). The priority may be indicated in the 1^{st}-stage SCI that indicates the resource reservation of the sub-channel(s).

As illustrated in step 1003 of FIG. 10, a UE 120a-c may determine reservations of SL-PRS resources, e.g., based on the procedure previously described in the context of the fourth main embodiment. The reserved SL-PRS resources can be determined with a two-stage reservation, i.e., with a first stage reservation 210a carried in a 1^{st}-stage SCI and a second stage reservation 210b carried in a 2^{nd}-stage SCI. The UE 120a-c may also determine RSRP(s) associated with the reserved SL-PRS resource(s). The RSRP associated with a reserved SL-PRS resource may be measured based on the SL-PRS sent on the reserved SL-PRS resource. This can be considered when the UE that sends the SL-PRS is different than the UE that sends the two-stage reservation. The RSRP may also be measured based on the DMRS within the PSCCH that carries the 1^{st}-stage SCI that indicates the first stage reservation 210a. This can be considered when the UE that sends the SL-PRS is the same UE that sends the two-stage reservation. The RSRP(s) are to be considered for the exclusion of resources in the mode 2 sensing procedure. The UE 120a-c may be (pre-)configured to measure the RSRP associated with a first stage reservation 210a of a SL-PRS resource based on the PSCCH DMRS of the PSCCH that carries the 1^{st}-stage SCI that indicates the first stage reservation 210a. In particular, the (pre-)configuration to measure the RSRP based on PSCCH DMRS for resource selection can be part of the (pre-)configuration of the resource pool for Rel. 18 UEs 120a-c. The (pre-)configuration may be indicated with a higher layer parameter. It may be indicated within the (pre-)configuration of the SL-ResourcePool information element. In addition, the UE 120a-c may determine a priority associated with a reserved SL-PRS resource. The priority may be indicated in the 1^{st}-stage SCI or in the 2^{nd}-stage SCI that is associated with the 1^{st}-stage SCI that carries the first stage reservation 210a.

As illustrated in step 1005 of FIG. 10, I UE 120a-c then performs the resource selection for a SL-PRS resource based on the reserved sub-channel(s) within semi-dedicated resources 260, the RSRPs associated with reserved sub-channel(s), priorities associated with transmissions on reserved sub-channel(s), reserved SL-PRS resources, RSRPs associated with reserved SL-PRS resources and optionally based on the priorities associated with reserved SL-PRS resources. The UE 120a-c first determines candidate SL-PRS resources. To determine the candidate resources, the UE 120a-c can exclude resources based on the reserved resources within semi-dedicated resources 260 as well as the associated RSRP and priority of a reserved resource. For example, if more than X sub-channels have been reserved within a semi-dedicated resource 260, the UE 120a-c can then exclude all the SL-PRS resources within the semi-dedicated resource 260. For the resource exclusion, a UE 120a-c may be (pre-)configured to exclude resources based on the associated RSRP and priority of the reserved sub-channels. For example, if more than X sub-channels have been reserved within a semi-dedicated resource 260 with an RSRP above an RSRP threshold RSRP₁, the UE 120a-c can then exclude all the SL-PRS resources within the semi-dedicated resource 260. Furthermore, if more than X sub-channels have been reserved within a semi-dedicated resource 260 with a priority higher than the priority of the SL-PRS the UE 120a-c wants to transmit, the UE 120a-c may then exclude all the SL-PRS resources within the semi-dedicated resource 260. The exclusion of a semi-dedicated resource 260 may be based on both conditions for the associated RSRP and priority of reserved resources.

The UE 120a-c may exclude also SL-PRS resources based on the reserved SL-PRS resources, i.e., if a SL-PRS resource within a semi-dedicated resource 260 has been reserved, the UE 120a-c excludes this SL-PRS resources. For the resource exclusion, the UE 120a-c can consider the RSRP and priority of the reserved SL-PRS resources. For example, the UE 120a-c can exclude a SL-PRS resource within a semi-dedicated resource 260 if it has an associated RSRP above an RSRP threshold RSRP₂. Furthermore, the UE 120a-c may exclude a SL-PRS resource within a semi-dedicated resource 260 if it has an associated priority above the priority of the SL-PRS that the UE 120a-c wants to transmit. The exclusion of a semi-SL-PRS resources can be based on both conditions for the associated RSRP and priority of reserved SL-PRS resources.

The UE 120a-c may also exclude resources based on half-duplex constraint similar to the legacy mode 2 sensing procedure. The remaining SL-PRS resources, i.e., within a selection window, after the exclusions of resources are considered to be candidate SL-PRS resources. The UE 120a-c may then select a SL-PRS resources among the candidate SL-PRS resources, e.g., it may select it randomly. If the percentage of candidate resources among the semi-dedicated is below a (pre-)configured threshold, the UE 120a-c may increase the RSRP thresholds used to exclude resources by a given amount, e.g., 3 dB, and repeat the procedure for the exclusion of resources. The values of X, RSRP₁, and RSRP₂ might be (pre-)configured to the UE as shown in FIG. 10.

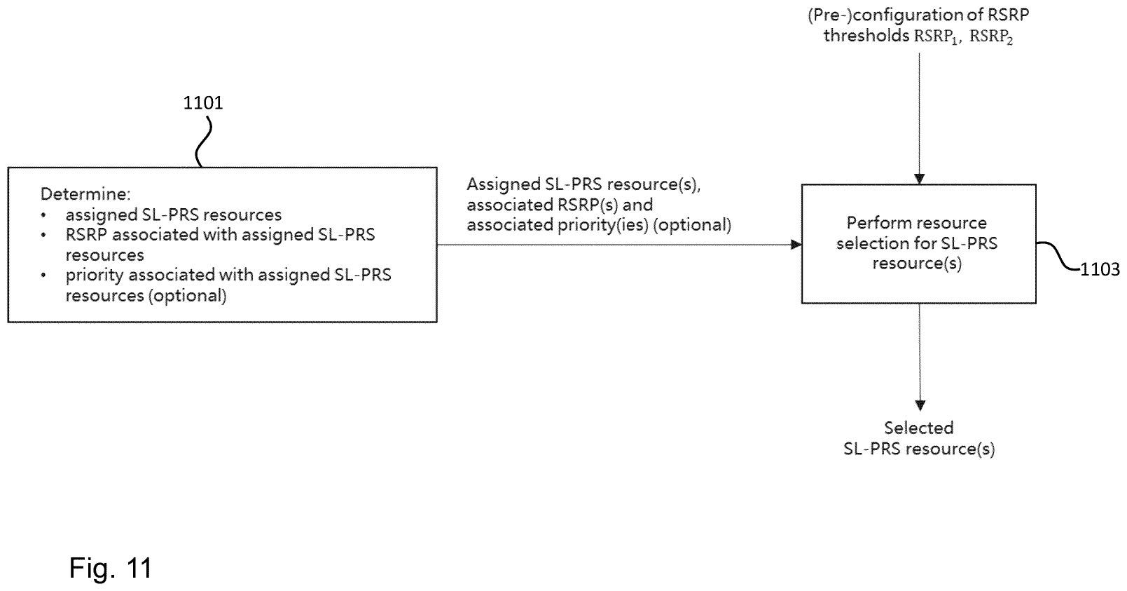

FIG. 11 shows a flow diagram illustrating another embodiment, where only reservations of SL-PRS resources for the resource selection with mode 2 are considered, i.e., resources are excluded based on reserved SL-PRS resources but not based on reserved sub-channels within semi-dedicated resources. The following description of steps 1101 and 1103 of FIG. 11 is similar to the description of the previous embodiment, but without considering the reserved sub-channels within semi-dedicated resources. In the embodiment shown in FIG. 11, a Rel. 18 UE 120a-c may reserve resources for a SL-PRS within a semi-dedicated resource 260 even if one or more sub-channels within the semi-dedicated resource 260 have been reserved by another UE 120a-d for a data transmission. The Rel. 18 UE 120a-c may ignore the reservations of sub-channels (i.e., for a data transmission) within semi-dedicated resources 260. The Rel. 18 UE 120a-c may not be aware of the reservations of sub-channels within semi-dedicated resources 260. If one or more sub-channels have been reserved within a semi-dedicated resource 260, in which a Rel. 18 UE 120a-c wants to transmit a SL-PRS resource, this can lead to a collision, i.e., a collision of the SL-PRS transmission of the Rel. 18 UE 120a-c with data transmissions of other UEs 120a-d. To avoid this, the pre-emption mechanism may be considered, where the transmission of SL-PRS is prioritized over data transmissions. For this purpose, the priority of the SL-PRS is (pre-)configured to be higher than the priority of data transmissions, i.e., of different traffic types. For this purpose, the pre-emption mechanism may be enabled in the resource pool. Pre-emption in a resource pool may be enabled with a parameter, e.g., sl-PreemptionEnable-r16, within the information element, i.e., SL-ResourcePool information element, which provides the (pre-)configuration of a resource pool.

Furthermore, legacy UEs 120d intending to send data may be (pre-)configured, i.e., with the pre-emption mechanism enabled, to check prior to a transmission if other UEs 120a-d have reserved the same sub-channels for a transmission with higher priority. With the pre-emption mechanism enabled, collisions can be avoided as a UE 120a-d would drop a reservation of a sub-channel within a semi-dedicated resource if it receives a reservation of the semi-dedicated resource (from a Rel. 18 UE 120a-c wanting to transmit a SL-PRS) for a transmission with higher priority than the UE's 120a-d intended transmission.

Moreover, Rel. 18 UEs 120a-c intending to send data may be (pre-)configured to exclude all resources from the semi-dedicated resources 260 during resource selection in mode 2. Rel. 18 UEs 120a-c may be aware of the semi-dedicated resources 260. In this way, Rel. 18 UEs 120a-c would not select sub-channels within the semi-dedicated resources 260 for a data transmission.

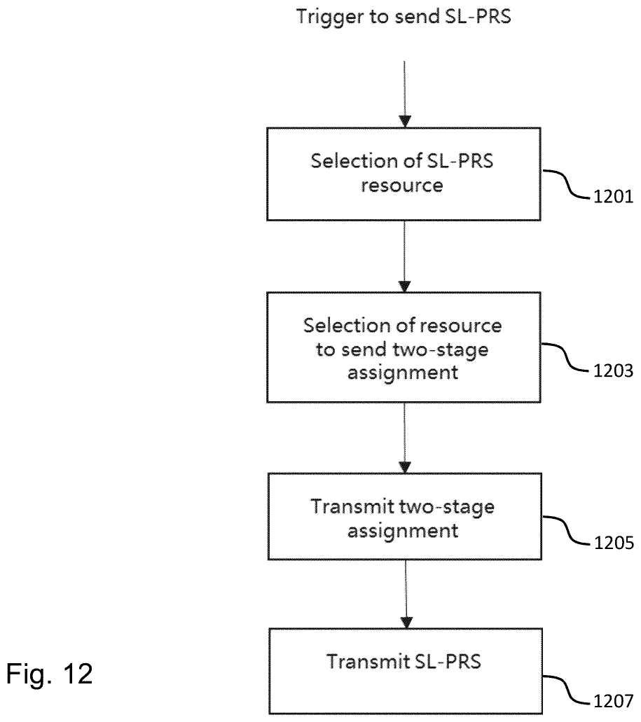

FIG. 12 shows a flow diagram illustrating processing steps of a further embodiment considering the resource selection for SL-PRS as well as for the resource that carries the two-stage reservation. After a UE 120a-c has been triggered to send SL-PRS, e.g., by the UE's own higher layers or by another UE 120a-c, the UE 120a-c selects a SL-PRS resource (step 1201 of FIG. 12). The resource selection of a SL-PRS resource may be performed with mode 1 resource allocation or with mode 2 resource allocation. The UE 120a-c also selects a resource for sending the two-stage reservation (step 1203 of FIG. 12). The resource for sending the two-stage reservation may consist of one sub-channel. The resource selection of this resource may be performed with mode 1 resource allocation or with mode 2 resource allocation. After the selection of the SL-PRS resource and the resource that shall carry the two-stage reservation, the UE 120a-c sends the two-stage reservation on the selected resource and the SL-PRS on the selected SL-PRS resource (step 1205 of FIG. 12). The UE 120a-c can send the two-stage reservation with a larger transmit power compared to the transmit power of a data transmission, i.e. of a PSSCH. In this exemplary embodiment the UE 120a-c sending the two-stage reservation of a SL-PRS resource may be the same UE 120a-c that sends the SL-PRS resource (step 1207 of FIG. 12). However, as already mentioned before, this may not be the case in general.

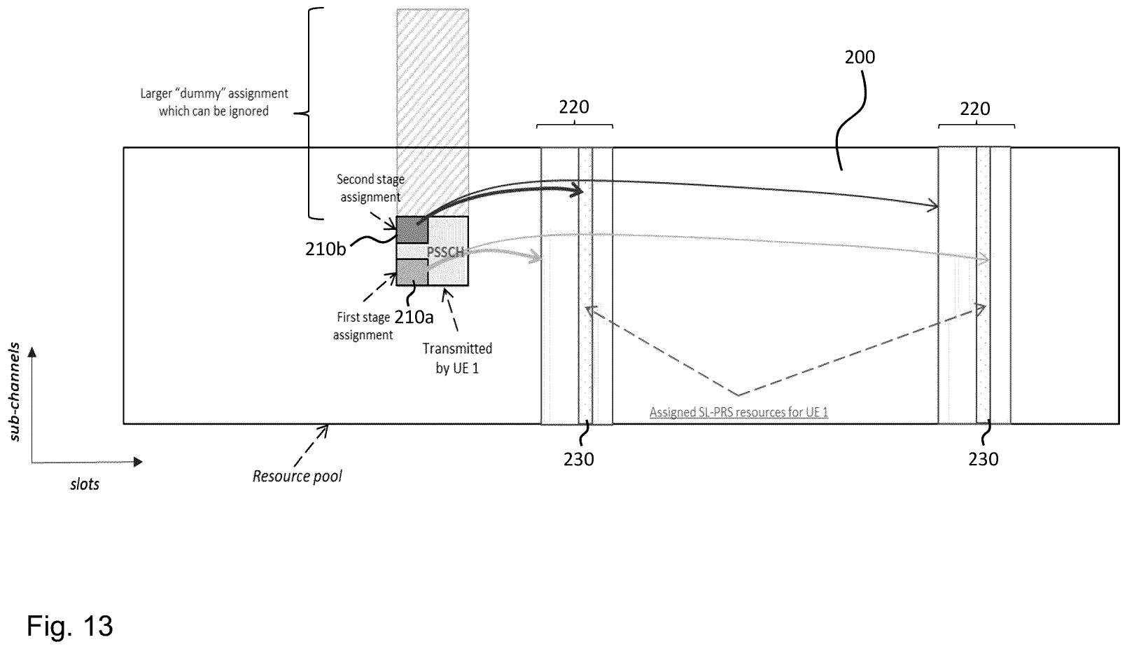

FIG. 13 illustrates a further embodiment of the transmission of the two-stage reservation on a selected sub-channel. The first stage reservation of a SL-PRS is sent in the 1^{st}-stage SCI carried in a PSCCH within the selected sub-channel. In Rel. 16/17 NR V2X, the 1^{st}-stage SCI may indicate the reservation of an initial transmission (i.e., the current transmission) of a TB, as well as the reservation of one or two subsequent resources, e.g., for retransmissions of the TB. A reservation comprises an indication of the frequency resource location (i.e., starting sub-channel index and number of sub-channels occupied by the transmission) and of the time resource location (i.e., time slot) of a transmission. According to embodiments disclosed herein, the two-stage reservation of a SL-PRS resource can be sent in one sub-channel. The first stage reservation 210a is sent within the 1^{st}-stage SCI carried by a PSCCH sent within the sub-channel as shown in FIG. 13. The first stage reservation 210a indicates a reservation of a semi-dedicated resource 260, which in this example occupies all the sub-channels in the resource pool. As the transmission of the two-stage reservation occupies one sub-channel, the reservation for the current transmission of the two-stage reservation (i.e., initial transmission) only needs to indicate that one sub-channel is occupied. On the other hand, the first stage reservation 210a indicates a reservation of all the sub-channels in a semi-dedicated, i.e., of all the sub-channels in the resource pool, for the transmission of the SL-PRS. In Rel. 16/17 NR V2X, the number of sub-channels occupied by the initial transmission and a retransmission are assumed to be the same, i.e. a resource reservation of an initial transmission and a resource reservation of a retransmission reserve the same number of contiguous sub-channels. However, the transmission of the two-stage reservation may not need to occupy the same number of sub-channels as a reserved semi-dedicated resource. The first stage reservation 210a can be indicated with a resource reservation carried by the 1^{st}-stage SCI, that is usually used to indicate a resource reservation of a retransmission. This would imply that the current transmission of a two-stage reservation also occupies the same number of channels as a reserved semi-dedicated resource. For this purpose, according to embodiments disclosed herein, Rel. 18 UEs 120a-c are (pre-)configured to ignore the larger implied reservation for a transmission of a two-stage reservation. After a UE 120a-c has determined that there is a first stage reservation 210a (i.e., it has detected the presence of a second stage reservation 210b), it knows that a reservation indicated in the 1^{st}-stage SCI is associated with a SL-PRS (i.e., it is a first stage reservation 210a) and thus, it can ignore the larger “dummy” reservation of the current transmission of a two-stage reservation. It only needs to decode information within the sub-channel with the PSCCH that carries the 1^{st}-stage SCI associated with a SL-PRS reservation. In this way, the larger reservation of the current transmission of a two-stage reservation is a dummy reservation. Rel. 18 UEs 120a-c may also be (pre-)configured to ignore this larger “dummy” reservation for their mode 2 sensing procedure.

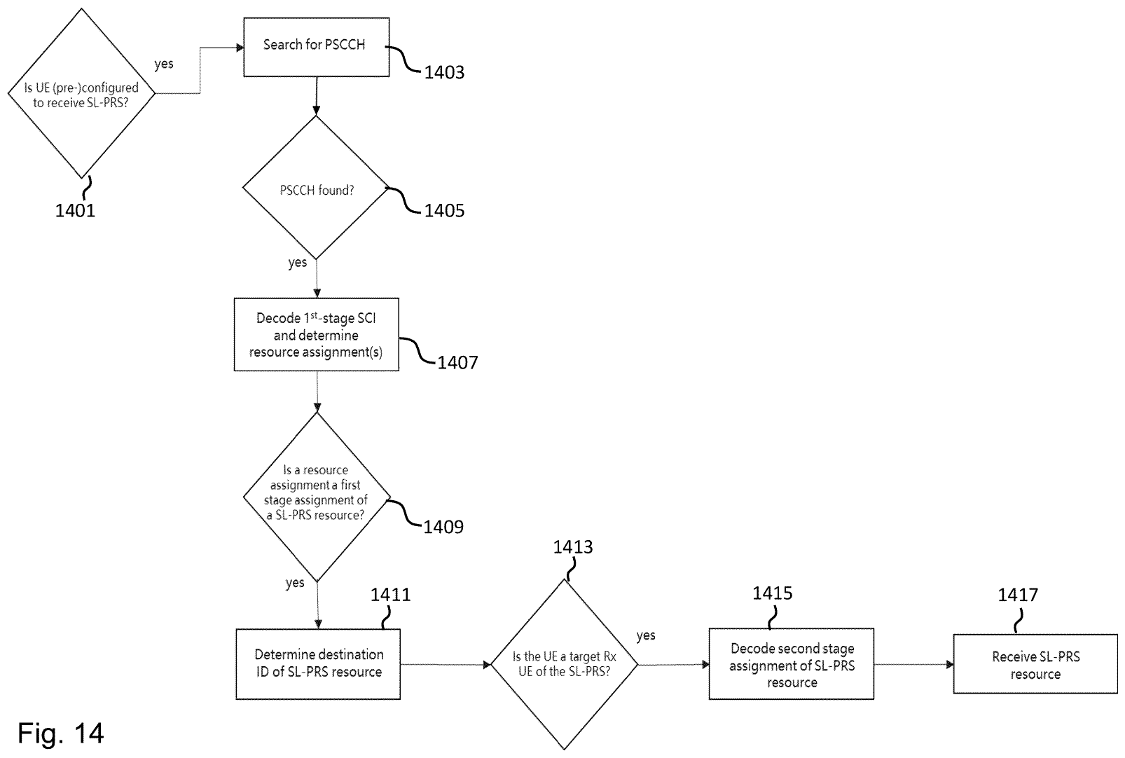

FIG. 14 shows a flowchart illustrating an embodiment of the reception of SL-PRS. A UE 120a-c first checks whether it has been (pre-)configured to receive SL-PRS (step 1401 of FIG. 14). This (pre-)configuration may be per UE 120a-c or it can be per resource pool. A UE 120a-c may be (pre-)configured not to receive SL-PRS, to avoid searching for the two-stage reservation and reduce its power consumption. If the UE 120a-c is (pre-)configured to receive SL-PRS, the UE 120a-c then searches for PSCCH (step 1403 of FIG. 14). Similar to the legacy procedure in Rel. 16 and Rel. 17, a UE 120a-c may search for a PSCCH at all potential locations of a PSCCH in each sub-channel in the slots of a resource pool. The presence of a PSCCH may be detected based on the PSCCH DMRS. If a PSCCH is found (step 1405 of FIG. 14), the UE 120a-c decodes the 1^{st}-stage SCI carried by the PSCCH and determines the resource reservation(s) indicated by the 1^{st}-stage SCI (step 1407 of FIG. 14). The UE 120a-c then determines whether an indicated resource reservation is for a data transmission or for a SL-PRS transmission (step 1409 of FIG. 14). The UE 120a-c checks whether a resource reservation indicated by a 1^{st}-stage SCI corresponds to a first stage reservation 210a of a SL-PRS resource (step 1409 of FIG. 14). This may be determined in different ways. A UE 120a-c may determine that a resource reservation of a given number of sub-channels corresponds to a first stage reservation 210a of a SL-PRS resource. A UE 120a-c may also determine that a resource reservation of a semi-dedicated resource 260 corresponds to a first stage reservation 210a of a SL-PRS. A UE 120a-c may also determine that a resource reservation is a first stage reservation 210a based on the presence of a second stage reservation 210b. The presence of a second stage reservation 210b may be indicated with one of the reserved bits in the 1^{st}-stage SCI or with the indication of a 2^{nd}-stage SCI format associated with the SL-PRS.

If the UE 120a-c detects a first stage reservation of a SL-PRS resource, it proceeds to determine the destination ID of the reserved SL-PRS resource (step 1411 of FIG. 14). The UE 120a-c is aware where and how to find the destination ID based on its (pre-)configuration. The destination ID may be sent with the source ID. The destination ID may be sent in the same sub-channel that carries the first stage reservation 210a. In particular, the source ID and destination ID may be carried in the 2^{nd}-stage SCI associated with the 1^{st}-stage SCI.

After determining the destination ID, the UE 120a-c checks whether it is a target Rx UE of the SL-PRS (step 1413 of FIG. 14), i.e., whether the UE 120a-c is an intended receiver of the SL-PRS. If the UE 120a-c is a target Rx UE of the reserved SL-PRS resource, it then proceeds to determine the second stage reservation 210b of the SL-PRS resource (step 1415 of FIG. 14). The UE 120a-c is aware where and how to find the second stage reservation 210b based on its (pre-)configuration. The second stage reservation 210b may be carried in the same sub-channel that carries the first stage reservation 210a. In particular, the second stage reservation 210b may be carried in the 2^{nd}-stage SCI associated with the 1^{st}-stage SCI. After decoding the second stage reservation 210b, the UE 120a-c determines the reserved SL-PRS resources.

After the UE 120a-c has determined the first and second stage reservation 210a,b of a SL-PRS resource, it knows in which semi-dedicated resource 260 and which SL-PRS resource it shall receive a SL-PRS (step 1417 of FIG. 14).

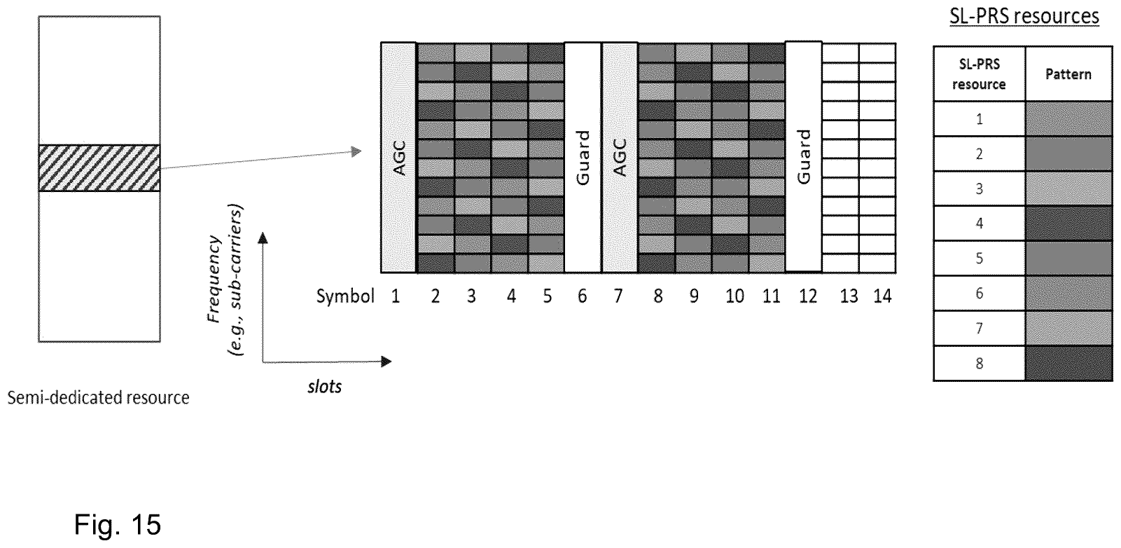

FIG. 15 illustrates an embodiment of the time and frequency allocation of several SL-PRS resources within a semi-dedicated resource. In the example shown in FIG. 15, 8 SL-PRS resources are depicted, where each SL-PRS resource spans 4 symbols and all the sub-channels within the semi-dedicated resource are arranged in a comb pattern. For simplicity, only a frequency chunk within the semi-dedicated resource is depicted, but the comb pattern can be repeated in the rest of the semi-dedicated resource. FIG. 15 also shows automatic gain control (AGC) symbols and gap or guard symbols. An AGC symbol allows a Rx UE to adjust the dynamic range based on a received signal. The guard symbol allows to switch from transmission to reception or from reception to transmission. Due to the half-duplex constraint, a UE 120a-c may not receive a SL-PRS when it is sending a SL-PRS at the same time, i.e., in the same symbol. Thus, a UE 120a-c sending SL-PRS resource 1 cannot receive SL-PRS resource 2. However, a UE 120a-c sending SL-PRS resource 1 can receive SL-PRS resource 5. The depicted example allows a UE 120a-c to send a SL-PRS in SL-PRS resource 1, 2, 3 or 4 and to receive a SL-PRS in SL-PRS resource 5, 6, 7 or 8. This allows a UE 120a-c to transmit a SL-PRS and receive a SL-PRS within the same semi-dedicated resource, i.e., within the same slot. More SL-PRS resources can be multiplexed within the semi-dedicated resource, i.e., by having one AGC symbol followed by 12 SL-PRS resources (e.g., in a comb pattern) and finally a guard symbol within the 14 symbols in a slot.

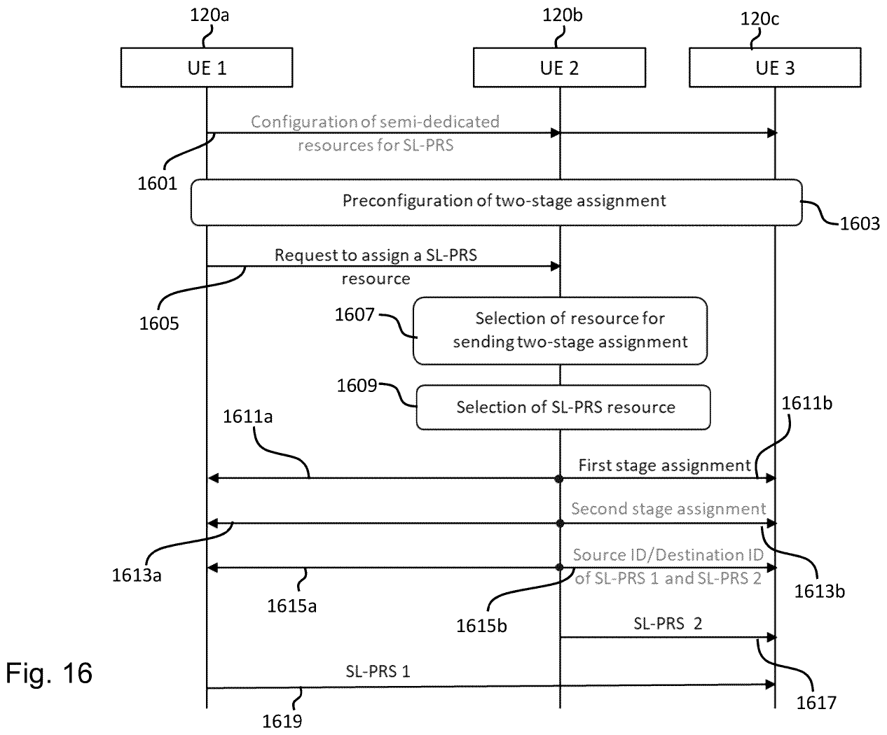

FIG. 16 illustrates a further embodiment for the case of a group of UEs 120a-c in an out of network coverage scenario. FIG. 16 shows a signaling diagram where the configuration of the semi-dedicated resources (step 1601 of FIG. 16) is done dynamically among the group of UEs 120a-c. This allows the UEs 120a-c within the group to have a common understanding of the SL-PRS resources within the group. The configuration can be provided by one UE 120a to the other UEs 120b,c, or the UEs 120a-c can agree on the configuration together. The pre-configuration for sending and receiving a two-stage reservation is also depicted (step 1603 of FIG. 16). The pre-configuration may be performed as in the embodiments described above. The first UE 120a (UE 1) may indicate to the second UE 120b (UE 2) to select a SL-PRS resource for the first UE 120a (step 1605 of FIG. 16). The second UE 102b selects resources for sending the two-stage reservation as well as for SL-PRS resources for the first and second UE 120a,b (steps 1607 and 1609 of FIG. 16). By way of example, the second UE 120b selects two SL-PRS resources within one semi-dedicated resource 260 for two transmissions of SL-PRS, namely one SL-PRS to be sent by the first UE 120a and one SL-PRS to be sent by the second UE 120b. The two SL-PRS resources may be multiplexed within one semi-dedicated resource, as described in the previous embodiment. The resource selection may be done with mode 2 resource allocation, i.e., as described in the previous embodiments. The UEs 120a-c could also be in network coverage and select resources based on mode 2 resource allocation. The second UE 102b selects a sub-channel for sending the two-stage reservation as well as for sending the source ID and destination ID of the two SL-PRS resources. The two selected SL-PRS resources are denoted as SL-PRS 1 and SL-PRS 2 to be sent by the first UE 120a and the second UE 120b, respectively. Afterwards, the second UE 120b sends the two-stage reservation (steps 1611a,b and 1613a,b of FIG. 16) as well as the source ID and destination ID of SL-PRS 1 and SL-PRS 2 (steps 1615a,b of FIG. 16) in the selected sub-channel, which is received by the first UE 120a and the third UE 120c (UE 3). The first UE 120a and the third UE 120c determine that there is a first stage reservation 210a of a SL-PRS resource. The third UE 120c determines as well that it is a target receiver of two SL-PRS resources based on the destination ID. The first UE 120a determines that the second UE 120b has reserved a SL-PRS resource for the first UE 120a, i.e. based on the source ID of SL-PRS 1. The first UE 120a then sends the SL-PRS 1 on the selected SL-PRS resource (step 1619 of FIG. 16). The second UE 120b then sends the SL-PRS 2 on the selected SL-PRS resource (step 1617 of FIG. 16). The third UE 120c receives SL-PRS 1 and SL-PRS 2 based on the two-stage reservation and the destination ID of both SL-PRS resources received in the selected sub-channel. In the depicted example, the first UE 120a is configured to check for a two-stage reservation sent by the second UE 120b.

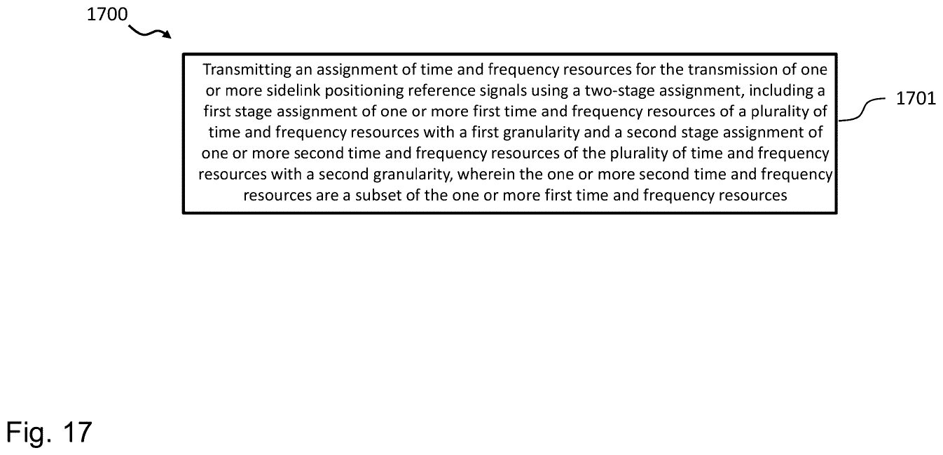

FIG. 17 is a flow diagram illustrating a method 1700 according to an embodiment for transmitting a two-stage assignment of time and frequency resources for the transmission of one or more sidelink positioning reference signals. The method 1700 comprises a step 1701 of transmitting the assignment using a two-stage assignment, including a first stage assignment 210a of one or more first time and frequency resources 220 of a plurality of time and frequency resources 200 with a first granularity and a second stage assignment 210b of one or more second time and frequency resources 230 of the plurality of time and frequency resources 200 with a second granularity, wherein the one or more second time and frequency resources 230 are a subset of the one or more first time and frequency resources 220.

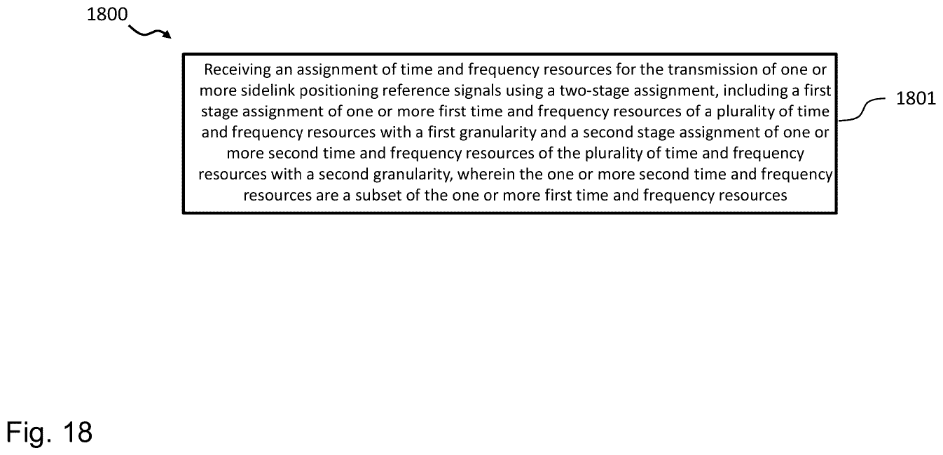

FIG. 18 is a flow diagram illustrating a method 1800 according to an embodiment for receiving a two-stage assignment of time and frequency resources for the transmission of one or more sidelink positioning reference signals. The method 1800 comprises a step 1801 of receiving the assignment using a two-stage assignment, including a first stage assignment 210a of one or more first time and frequency resources 220 of a plurality of time and frequency resources 200 with a first granularity and a second stage assignment 210b of one or more second time and frequency resources 230 of the plurality of time and frequency resources 200 with a second granularity, wherein the one or more second time and frequency resources 230 are a subset of the one or more first time and frequency resources 220.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

What is claimed is:

1. A user equipment, UE, (120a) for transmitting an assignment of time and frequency resources for the transmission of one or more sidelink positioning reference signals, SL-PRSs, wherein the UE (120a) is configured to transmit the assignment using a two-stage assignment, including a first stage assignment (210a) of one or more first time and frequency resources (220) of a plurality of time and frequency resources (200) with a first granularity and a second stage assignment (210b) of one or more second time and frequency resources (230) of the plurality of time and frequency resources (200) with a second granularity, wherein the one or more second time and frequency resources (230) are a subset of the one or more first time and frequency resources (220).

2. The UE (120a) of claim 1, wherein the UE (120a) is configured to transmit a first stage sidelink control information, SCI, and wherein the first stage SCI comprises the first stage assignment (210a).

3. The UE (120a) of claim 2, wherein the UE (120a) is configured to transmit a second stage sidelink control information, SCI, and wherein the second stage SCI comprises the second stage assignment (210b).

4. The UE (120a) of claim 3, wherein the first stage SCI comprises information indicative of the presence of the second stage assignment (210b).

5. The UE (120a) of claim 4, wherein the first stage SCI further comprises information about a format of the second stage SCI and/or wherein one or more reserved bits of the first stage SCI comprises the information indicative of the presence of the second stage assignment (210b).

6. The UE (120a) of claim 1, wherein the plurality of time and frequency resources (200) comprise a plurality of slots and a plurality of sub-channels.

7. The UE (120a) of claim 6, wherein the UE (120a) is configured to transmit the two-stage assignment within one or more sub-channels of the plurality of slots and the plurality of sub-channels.

8. The UE (120a) of claim 7, wherein the UE (120a) is configured to transmit control information associated with the one or more SL-PRSs within the one or more sub-channels of the plurality of slots and the plurality of sub-channels that carry the two-stage assignment.

9. The UE (120a) of claim 6, wherein the UE (120a) is configured to transmit the two-stage assignment in a slot prior to one or more slots including the first time and frequency resources (220).

10. The UE (120a) of claim 6, wherein the UE (120a) is configured to transmit the two-stage assignment in a slot including the first time and frequency resources (220).

11. The UE (120a) of claim 1, wherein the UE (120a) is configured to transmit the one or more SL-PRSs on the second time and frequency resources (230) as indicated by the second stage assignment (210b).

12. The UE (120a) of claim 1, wherein the UE (120a) is configured to transmit the one or more SL-PRSs on the second time and frequency resources (230) as indicated by the first (210a) and the second stage assignment (210b).

13. The UE (120a) of claim 1, wherein the UE (120a) is configured to transmit the assignment of time and frequency resources using the two-stage assignment for the transmission of one or more of the one or more SL-PRSs by a further UE (120b,c).

14. The UE (120a) of claim 1, wherein the first granularity is a sub-channel of a slot.

15. The UE (120a) of claim 14, wherein the plurality of time and frequency resources (200) comprise one or more SL-PRS resources (260) having the second granularity.

16. The UE (120a) of claim 1, wherein the plurality of time and frequency resources (200) comprise one or more SL-PRS resources (260) and wherein the UE (120a) and/or a further UE (120b,c) is configured to transmit the one or more SL-PRSs on one or more SL-PRS resources of the one or more SL-PRS resources (260).

17. The UE (120a) of claim 16, wherein the UE (120a) is configured to transmit the two-stage assignment in one or more time and frequency resources of the plurality of time and frequency resources (200) different to the one or more SL-PRS resources (260).

18. The UE (120a) of claim 17, wherein the UE (120a) is configured to transmit data in one or more time and frequency resources of the plurality of time and frequency resources (200) including one or more of the one or more SL-PRS resources (260).

19. A method (1700) for transmitting an assignment of time and frequency resources for the transmission of one or more sidelink positioning reference signals, SL-PRSs, wherein the method (1700) comprises transmitting (1701) the assignment using a two-stage assignment, including a first stage assignment (210a) of one or more first time and frequency resources (220) of a plurality of time and frequency resources (200) with a first granularity and a second stage assignment (210b) of one or more second time and frequency resources (230) of the plurality of time and frequency resources (200) with a second granularity, wherein the one or more second time and frequency resources (230) are a subset of the one or more first time and frequency resources (220).

20. A non-transitory computer-readable storage medium for storing program code which causes a computer or a processor to perform the method (1700) for transmitting an assignment of time and frequency resources for the transmission of one or more sidelink positioning reference signals, SL-PRSs, wherein the method (1700) comprises transmitting (1701) the assignment using a two-stage assignment, including a first stage assignment (210a) of one or more first time and frequency resources (220) of a plurality of time and frequency resources (200) with a first granularity and a second stage assignment (210b) of one or more second time and frequency resources (230) of the plurality of time and frequency resources (200) with a second granularity, wherein the one or more second time and frequency resources (230) are a subset of the one or more first time and frequency resources (220).
